(19) United States
(12) Patent Application Publication
(10) Pub. No.: US 2024/0378547 A1
(43) Pub. Date: Nov. 14, 2024

(54) ELECTRONIC TRANSPORTATION MANAGEMENT SYSTEM AND METHOD

(71) Applicant: RunBuggy OMI, Inc., Phoenix, AZ (US)

(72) Inventors: Patrick Weinkam, San Francisco, CA (US); Sasha Jovicic, Parkland, FL (US); James Romero, Irvine, CA (US); Kevin Malik, Scottsdale, AZ (US); Bryan Boye, Canfield, OH (US)

(21) Appl. No.: 18/643,428

(22) Filed: Apr. 23, 2024

Related U.S. Application Data
(60) Provisional application No. 63/501,578, filed on May 11, 2023.

(51) Int. Cl. G06Q 10/0835; G06Q 10/087

(52) U.S. Cl. CPC G06Q 10/08355; G06Q 10/087

(57) ABSTRACT

Systems and methods for a transportation management system provide for: receiving one or more load identifiers; providing one or more internal transporter indications and an open marketplace transporter indication for an open marketplace system; receiving a user input to select a selected transporter indication among the one or more internal transporter indications and the open marketplace transporter indication; generating a first order based on the one or more load identifiers and the selected transporter indication; in response to the selected transporter indication being selected from the one or more internal transporter indications, outputting the first order to an internal transporter corresponding to the selected transporter indication; and in response to the selected transporter indication being selected from the open marketplace transporter indication, outputting the first order to the open marketplace system.

### CROSS-REFERENCE TO RELATED APPLICATIONS

This application claims priority to U.S. Provisional Application No. 63/501,578, filed on May 11, 2023, titled “SYSTEM AND METHOD FOR TRANSPORTATION MANAGEMENT,” which is hereby incorporated by reference in its entirety.

### SUMMARY

The disclosed technology relates to systems and methods for an electronic transportation management system (TMS). Some embodiments of the disclosure provide a TMS that includes one or more server hardware computing devices or client hardware computing devices, communicatively coupled to a network, and each including at least one processor executing specific computer-executable instructions within a memory that, when executed, cause the system to: receive one or more load identifiers, provide one or more internal transporter indications and an open marketplace transporter indication for an open marketplace system, receive a user input to select a selected transporter indication among the one or more internal transporter indications and the open marketplace transporter indication, generate a first order based on the one or more load identifiers and the selected transporter indication, output the first order to an internal transporter corresponding to the selected transporter indication in response to the selected transporter indication being selected from the one or more internal transporter indications, and output the first order to the open marketplace system in response to the selected transporter indication being selected from the open marketplace transporter indication.

Other embodiments of the disclosure provide a TMS that includes one or more server hardware computing devices or client hardware computing devices, communicatively coupled to a network, and each including at least one processor executing specific computer-executable instructions within a memory that, when executed, cause the system to: receive one or more load identifiers. Each load identifier is associated with a pickup location and a destination location. The at least one processor further causes the system to: determine a transporter for the one or more load identifiers; generate a first order based on the one or more load identifiers and the transporter, generate a transportation task that is associated with the one or more load identifiers and that defines at least one trigger condition and a triggered action to be performed when the at least one trigger condition is satisfied, and execute the transportation task by performing the triggered action in response to satisfaction of the at least one trigger condition.

Other embodiments of the disclosure provide a system that includes one or more server hardware computing devices or client hardware computing devices, communicatively coupled to a network, and each including at least one processor executing specific computer-executable instructions within a memory that, when executed, cause the system to: receive one or more load identifiers, provide a group associated with the one or more load identifiers based on at least one of: a pickup location, a drop-off location, a delivery date, or a route of each of the one or more load identifiers, providing one or more internal transporter indications and an open marketplace transporter indication for an open marketplace transporter in an open marketplace system, receive a user input to select the group and a selected transporter indication among the one or more internal transporter indications and the open marketplace transporter indication, generate a first order based on the group and the selected transporter indication, output the first order to an internal transporter corresponding to the selected transporter indication in response to the selected transporter indication being selected from the one or more internal transporter indications, and output the first order to the open marketplace system in response to the selected transporter indication being selected from the open marketplace transporter indication.

Other embodiments of the disclosure provide a system that includes one or more server hardware computing devices or client hardware computing devices, communicatively coupled to a network, and each including at least one processor executing specific computer-executable instructions within a memory that, when executed, cause the system to: receive one or more load identifiers. Each load identifier is associated with a pickup location and a destination location. The at least one processor further causes the system to: generate a preorder based on the one or more load identifiers, provide a graphical automation definition interface including a plurality of automation rule templates, and receive a user input for a first automation rule template of the plurality of automation rule templates. The first automation rule template defines at least one trigger condition to perform a triggered action. The at least one processor further causes the system to: identify a first transporter of a plurality of transporters for the one or more load identifiers in response to the user input and generate a first order based on the one or more load identifiers and the first transporter by performing the triggered action in response to satisfaction of the at least one trigger condition. The first transporter satisfies the at least one trigger condition of the first automation rule template.

Other embodiments of the disclosure provide a system that includes one or more server hardware computing devices or client hardware computing devices, communicatively coupled to a network, and each including at least one processor executing specific computer-executable instructions within a memory that, when executed, cause the system to: generate a first transportation panel on a graphic user interface and generate a second transportation panel on the graphic user interface. The first transportation panel represents a first transportation function for the TMS, and the second transportation panel represents a second transportation function for an external ancillary system. The TMS is heterogeneous from the external ancillary system. The at least one processor further causes the system to: identify a first communication data format of the first transportation function and a second communication data format of the second transportation function, generate a transportation integration link on the graphical user interface between the first transportation panel and the second transportation panel to define a TMS integration application programming interface (API) by mapping the first communication data format and the second communication data format, and communicate, via the TMS integration API being executed by the electronic processor, between the TMS and the external ancillary system.

At least in some embodiments described herein, improved systems and methods are provided that may effectively integrate heterogeneous systems to provide a unified TMS, minimize system resource usage via distributed processing, and enhance data security by separate data management in the heterogeneous systems. The above features and advantages of the present invention will be better understood from the following detailed description taken in conjunction with the accompanying drawings.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 illustrates a system level block diagram for providing a transportation management system (TMS) according to some embodiments.

FIG. 2 illustrates a graphical user interface of a TMS according to some embodiments.

FIG. 3 is an example graphical user interface displaying a dashboard for a TMS according to some embodiments.

FIG. 4 is a flowchart illustrating an example method and technique for a TMS according to some embodiments.

FIG. 5 is a graphical user interface for load identifier generation according to some embodiments.

FIG. 6 is a graphical user interface for preorder generation with load identifier(s) according to some embodiments.

FIG. 7 is a graphical user interface for a list of preorders according to some embodiments.

FIG. 8 is a graphical user interface for assignment of a transporter or a driver or to the open marketplace according to some embodiments.

FIG. 9 is a graphical user interface for transporter assignment according to some embodiments.

FIG. 10 is a graphical user interface for driver assignment according to some embodiments.

FIG. 11 is a graphical user interface for driver management according to some embodiments.

FIG. 12 is a graphical user interface for assignment to an open marketplace system according to some embodiments.

FIG. 13 is a graphical user interface for order generation according to some embodiments.

FIG. 14 is another graphical user interface for order generation according to some embodiments.

FIG. 15 is a graphical user interface for order details according to some embodiments.

FIG. 16 is a graphical user interface for order management according to some embodiments.

FIG. 17 is another graphical user interface for order management according to some embodiments.

FIG. 18 is a graphical user interface for a transporter to claim an order according to some embodiments.

FIG. 19 is a flowchart illustrating an example method and technique for transportation task generation and execution in a t TMS according to some embodiments.

FIG. 20 is a graphical user interface for transportation task generation and/or management according to some embodiments.

FIG. 21 is a flowchart illustrating an example method and technique for grouping in a TMS according to some embodiments.

FIG. 22 is a flowchart illustrating an example method and technique for automation in a TMS according to some embodiments.

FIG. 23 is an example graphical user interface showing a list of automation rule templates in a TMS according to some embodiments.

FIG. 24 is an example graphical user interface for user configuration or modification of an automation rule template in a TMS according to some embodiments.

FIG. 25 is a graphical user interface having a list of root tables for user configuration or modification of an automation rule template in a TMS according to some embodiments.

FIG. 26 is an example root table for user configuration or modification of an automation rule template on a graphical user interface of a TMS according to some embodiments.

FIG. 27 is a graphical user interface having an example history data in a TMS according to some embodiments.

FIG. 28 is a flowchart illustrating an example method and technique for system integration in a TMS according to some embodiments.

FIG. 29 is an example graphical user interface showing a list of system integration templates in a TMS according to some embodiments.

FIG. 30 is an example graphical user interface showing a system integration template in a TMS according to some embodiments.

### DETAILED DESCRIPTION

Electronic transportation management systems include software solutions to help companies manage their transportation operations. However, in some scenarios, the inhouse transporter of a transportation company in an existing transportation management system may not have enough capacity to transport loads. In other scenarios, using a transportation service of a third-party transportation company or an individual transporter who has a truck can be more efficient and more cost-effective than using the inhouse transporter. To use the transportation service of a third-party transportation company or an individual transporter, the personnel of the transportation company are required to search each third-party transportation company or a proper individual transporter, which is reputable and available. Even if the personnel can find a proper third-party transportation company or individual, the personnel are required to manage orders using the third-party transportation company's transportation management system and/or manually regenerate internal orders with possible clerical errors in the internal transportation management system. In some scenarios, separate transportation management systems may be used for managing different groups of transporters, where the separate transportation management systems are unable to communicate with one another. The lack of communication between systems can prevent a transportation management system from accessing relevant transportation data (e.g., regarding available transporters, transporter cost data, transporter reputation data, etc.) maintained on separate databases. Further, in some examples, transportation management systems may be rigidly constructed and unable to offer end-users the ability for customization and integration with other end-user software systems. The lack of interoperability of a transportation management system with other transportation management systems and other software systems can lead to inefficient transport management systems, transportation management systems with less functionality, overly manual processes, and errors and inefficiencies in transport management.

Some embodiments described herein provide solutions to these and other problems by providing improved systems and methods for an electronic transportation management system (TMS). For example, the disclosed systems and methods can provide a unified TMS platform or system to integrate heterogeneous transportation management systems (e.g., an TMS for the transportation company and an open marketplace system) and/or external ancillary systems (e.g., an external billing system, a load management system, etc.). In addition, the disclosed systems and methods can provide a unified transportation logistics operation information by dynamically obtaining the information from the inhouse transporter, other partner transporters using the same TMS platform, and the other external transporters using a heterogeneous TMS system (e.g., the open marketplace system). Furthermore, the disclosed systems and methods can reduce system resource usage and improve data processing via distributed computer processing in different transportation management systems. Moreover, the disclosed systems and methods can enhance data security by separate data management of transport orders in the heterogeneous systems. Finally, the disclosed systems and methods can provide optimized transportation logistics and streamline transport orders with automated operations using configurable transportation tasks and grouping features.

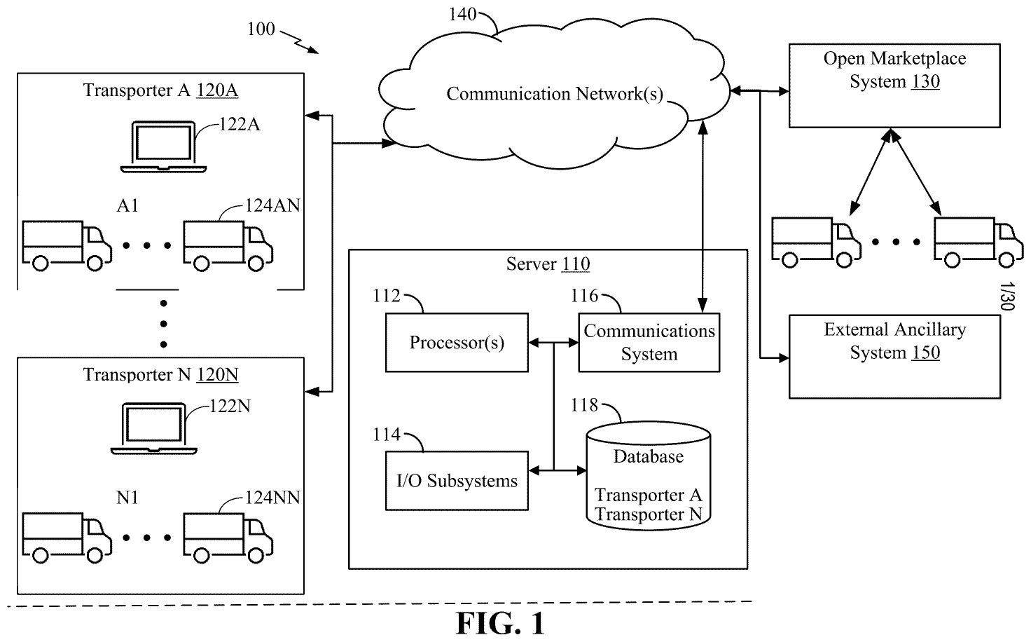

FIG. 1 illustrates a system level block diagram for providing a TMS in a distributed computing environment 100. The distributed computing environment 100 can include a server 110 implementing the transportation management system. The distributed computing environment 100 can further include one or more transporters 120, an open marketplace system 130, and external ancillary system(s) 150. The one or more transporters 120, the open marketplace system 130, and/or the external ancillary system(s) 150 can be communicatively coupled via one or more communication network(s) 140 to the server 110 for transportation operations.

The server 110 can include one or more server(s) (e.g., cloud servers, data servers, computing devices, computers, etc. and collectively referred to herein as “the server 110”) and other components that may implement certain embodiments and features (e.g., the TMS or platform) described herein. Other devices, such as specialized sensor devices, etc., may interact with the server 110. In some examples, the server 110 can include one or more processor(s) 112 (collectively referred to herein as “the processor 112”). In some embodiments, the processor 112 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc. In some examples, the processor(s) 112 retrieve and execute TMS software (e.g., stored in a memory of the server 110 or another accessible memory) to implement the TMS.

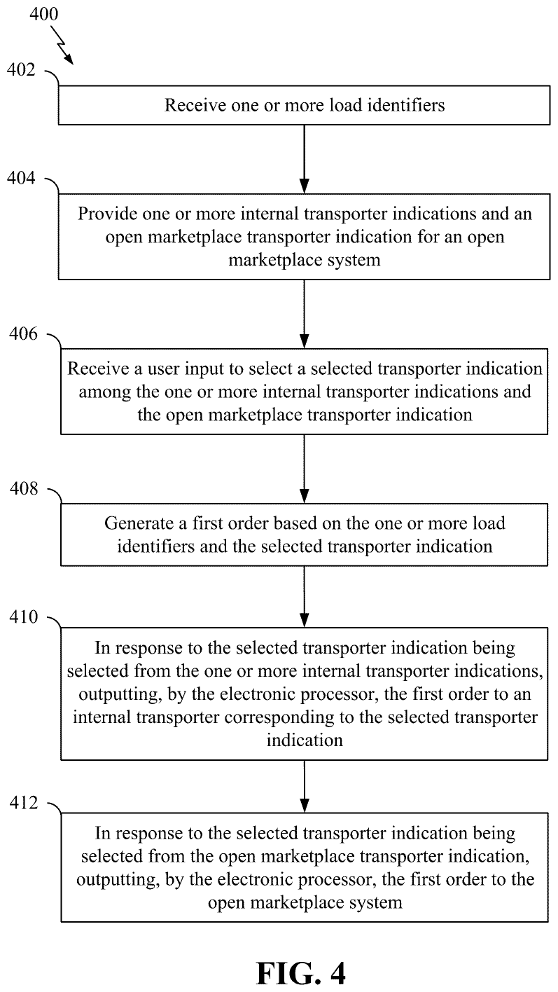

In further examples, the server 110 can further include a database 118. The database 118 can include any suitable storage device or devices that can be used to store suitable data (e.g., the TMS, load identifier(s), preorder(s), order(s), truck information, driver information, internal transporter information, automation rule template(s), system integration template(s), etc.) and instructions that can be used, for example, by the processor 112 to receive load identifier(s), provide internal transporter indication(s) and an open marketplace transporter indication, receive user input(s) to select a selected transporter indication, generate preorder(s), determine and providing group(s) based on load identifiers, generate order(s), output order(s) to internal transporter(s) and/or open marketplace system, determine partner transporter(s), display statuses of orders, obtain statuses of orders from the open marketplace system, generate transportation task(s), configure automation rule template(s), and/or configure system integration template(s). The database 118 can include any suitable volatile memory, non-volatile memory, storage, or any suitable combination thereof. For example, the database 118 can include random access memory (RAM), read-only memory (ROM), electronically-erasable programmable read-only memory (EEPROM), one or more flash drives, one or more hard disks, one or more solid state drives, one or more optical drives, etc. In some examples, the processor 112 can execute at least a portion of the computer program stored in the database 118 to perform one or more data processing transportation tasks described herein and transmit/receive information via the communications system 116, etc. In further examples, the processor 112 can execute at least a portion of process 400, 1900, 2100, 2200, and/or 2800 described below in connection with FIGS. 4, 19, 21, 22, and/or 28.

In further examples, the server 110 can further include a communications system 116, also referred to as a network interface. The communications system 116 can include any suitable hardware, firmware, and/or software for communicating information over communication network 140 and/or any other suitable communication networks. For example, the communications system 116 can include one or more transceivers, one or more communication chips and/or chip sets, etc. In a more particular example, the communications system 116 can include hardware, firmware and/or software that can be used to establish a Wi-Fi connection, a Bluetooth connection, a cellular connection, an Ethernet connection, etc.

In further examples, the server 110 can receive or transmit information from or to client device(s) (e.g., company computing device 122A, 122N, driver computing device 124A1, 124AN, 124N1, 124NN and collectively referred to herein as “the client devices 122, 124”) in the transporter(s) 120A, 120N (collectively referred to herein as “the transporter 120”) and/or any suitable system (e.g., the open marketplace system 130, external ancillary system(s) 150, etc.) over one or more communication network(s) 140. In some examples, the communication network(s) 140 can be any suitable communication network or combination of communication networks. For example, the communication network(s) 140 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, the communication network(s) 140 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

In further examples, the server 110 can further include an input/output subsystem 114. The I/O subsystem 114 can include one or more device controller(s) for one or more user interface input devices and/or user interface output devices, possibly integrated with the server 110 (e.g., integrated audio/video systems, and/or touchscreen displays), or may be separate peripheral devices which are attachable/detachable from the server 110. Input may include keyboard or mouse input, audio input (e.g., spoken commands), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, speakers, digital cameras, digital camcorders, webcams, and the like. In general, use of the term “output device” is intended to include all possible types of devices and mechanisms for outputting information from computing system 100, such as to a user (e.g., via a display device) or any other computing system, such as a second computing system. In an example, output devices may include one or more display subsystems and/or display devices that visually convey text, graphics, and audio/video information (e.g., cathode ray tube (CRT) displays, flat-panel devices, liquid crystal display (LCD) or plasma display devices, projection devices, touch screens, etc.), and/or may include one or more non-visual display subsystems and/or non-visual display devices, such as audio output devices, etc. As non-limiting examples, output devices may include, indicator lights, monitors, printers, speakers, headphones, automotive navigation systems, plotters, voice output devices, modems, etc. In other examples, the input data and/or output data via the communication network(s) 140 from client devices 122, 124 or other system (e.g., the open marketplace system 130, external ancillary system(s) 150, etc.).

The one or more transporters 120A, 120N can include one or more client devices, and other components that may implement certain embodiments and features described herein. Other devices, such as specialized sensor devices, location tracking devices, etc., may interact with the client computing device(s). Each transporter 120A, 120N can include one or more processor(s), an I/O subsystem, a communications system, and/or a database, which are substantially similar to the components in the server 110. In some examples, a client computing device in each transporter 120A, 120N can be a company computing device 122A, 122N or a driver computing device 124A1, 124AN, 124N1, 124NN. Thus, each transporter 120A, 120N can include one or more company computing devices 122A, 122N and/or one or more driver computing device 124A1, 124AN, 124N1, 124NN. In some examples, the company computing device 122A, 122N can access the server 110 via the communication network 140 to perform transportation operations (e.g., providing load identifier(s), providing driver/truck information, assigning drivers to trucks, generating preorder(s), generating order(s), grouping preorders and/or orders, outputting order(s) to an internal transporter or an open marketplace system, etc.). In further examples, a driver computing device 124A1, 124AN, 124N1, 124NN can be carried by a driver and correspond to or be assigned to a vehicle (e.g., a Class 1 truck, a Class 2a truck, a Class 2B truck, a Class 3 truck, a Class 4 truck, a Class 5 truck, a Class 6 truck, a Class 7 truck, a Class 8 truck, an airplane, a vessel, or any other suitable vehicle having a capacity to carry a load). The driver computing device 124A1, 124AN, 124N1, 124NN can provide and update a transportation order status (e.g., available to perform an order, ready to pick up load(s), arriving at a pickup location, moving to a drop-off location, arriving at a drop-off location, completing an order, etc.). In some examples, the driver computing device 124A1, 124AN, 124N1, 124NN can be coupled with a location tracking device to provide location information of the driver computing device 124A1, 124AN, 124N1, 124NN to the server 110.

In some examples, when the transporter A 120A uses the TMS in the server 110, the transporter A 120A is the inhouse transporter while other transporters 120N using the TMS in the server 110 are partner transporters. Then, the TMS allows the transporter A 120A to use the internal fleet vehicles 124A1, 124AN, partner transporters' fleet vehicles 124N1, 124NN via partner transporters 120N in the same TMS, and/or open marketplace transporter 132A, 132N from a heterogeneous system (i.e., the open marketplace system 130). On the other hand, when the transporter N 120N uses the TMS in the server 110, the transporter N 120N is the inhouse transporter while other transporters 120A using the TMS in the server 110 are partner transporters. Then, the TMS allows the transporter N 120N to use the internal fleet vehicle 124N1, 124NN, partner transporters 120A to use partner transporters' fleet vehicle 124A1, 124AN in the same TMS, and/or open marketplace transporter 132A, 132N from a heterogeneous system (i.e., the open marketplace system 130).

In some examples, the open marketplace system 130 provides a transportation service solution by connecting load shippers and external transporters. The open marketplace system 130 allows shippers to connect with shippers' existing management systems to integrate load transportation services. For transporters, the open marketplace system 130 provides custom software solutions to find and manage transportation loads. In some scenarios, the TMS implemented via the server 110 and the open marketplace system 130 are heterogeneous in that the open marketplace system 130 is logically and/or physically separated from the TMS. In some examples, the open marketplace system 130 can have a logically or physically separated database from the database 118 in the server 110. In such examples, the server 110 outputs a transportation order of load(s) to the open marketplace system 130 and receives or obtains a status of the order from the open marketplace system 130. The open marketplace system 130 generates an open marketplace order based on the order from the server 110 by determining or assigning a transporter 132A, 132N in the open marketplace system 130. Then, the open marketplace system 130 provides or updates the status of the open marketplace order for the server 110.

In some examples, the external ancillary system(s) 150 can include an external ancillary payment system, an external ancillary transporter system, an external ancillary TMS, or any other external ancillary suitable system. In some scenarios, the TMS implemented via the server 110 and the external ancillary system(s) 150 are heterogeneous in that the external ancillary system(s) is logically and/or physically separated from the TMS. In some examples, the external ancillary system(s) 150 can be integrated into the TMS by generating transportation integration link using TMS integration application programming interface(s) (API) between the TMS and the external ancillary system(s). The server 110 allows users in the TMS to manage transactions for the external ancillary system(s) through the TMS. Thus, the users in the TMS does not need to independently access the external ancillary system(s).

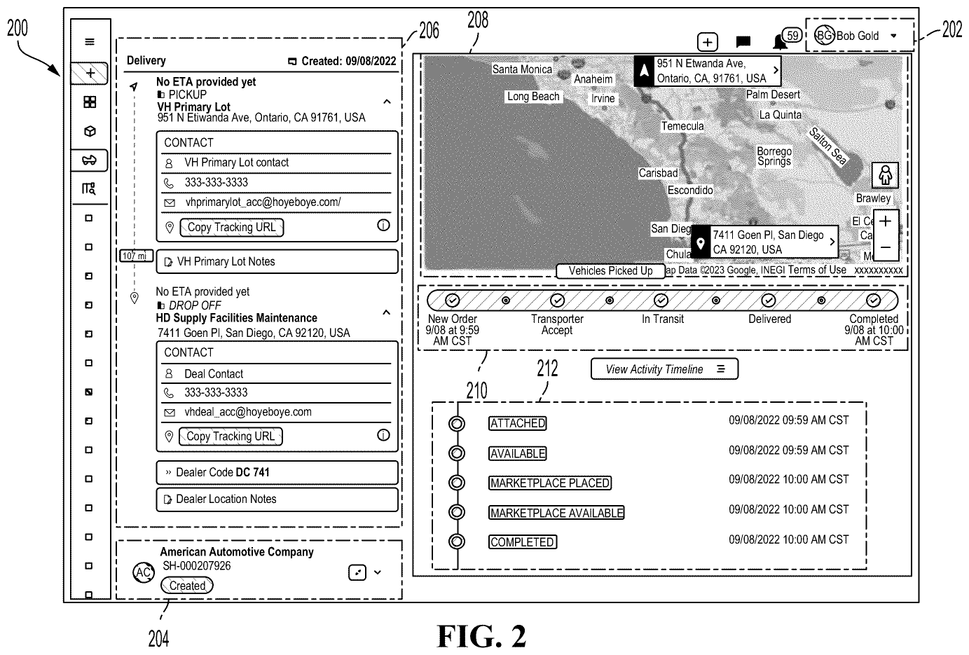

FIG. 2 illustrates a graphical user interface of a TMS. The TMS implemented on the server 110 with one or more client devices 122, 124 facilitates transportation operations (e.g., generating and managing preorder(s) and order(s) to transport load(s)) for transporter(s)). For example, the server 110 may generate a GUI screen 200 to be shown on client devices 122, 124 of users for a transporter 120A, 120N to perform transportation operations. The GUI screen 200 can be adaptively shown to include more or less components in the GUI screen 200 based on the types of a client device 122, 124 (e.g., a laptop computer, a mobile device, etc.). In some examples, the GUI screen 200 can include user information related to the user 202. The user 202 can be a transporter (e.g., a driver, a company user, or a suitable person to perform transportation operations for the transporter), a TMS user, or any other suitable user. In further examples, the GUI screen 200 can be adaptively shown to include more or less components in the GUI screen 200 based on the type of computing device for the user 202 (a company computing device 122A, 122N, or a driver computing device 124A1, 124AN, 124N1, 124NN, etc.). Referring again to FIG. 1, when the user 202 is associated with transporter A 120A, the user 202 can be associated with a company computing device 122A or a driver computing device 124A1, 124AN while transporter N 120N is a partner transportation in the same TMS implemented by the server 110.

In some examples, the GUI screen 200 can include information associated with an order. In some examples, the order indicates a transport order to ship one or more loads by a transporter (e.g., internal fleet vehicles of an inhouse transporter, partner fleet vehicles of partner transporters, vehicles of open market transporters) from a pickup location to a drop-off location for a shipper with/without other suitable conditions (e.g., pickup date and time deadlines, drop-off date and time deadlines, transport cost, etc.). For example, the GUI screen 200 can include transporter information 204, order information 206, location information 208, status information 210, activity information 212, and/or any other suitable information associated with the order.

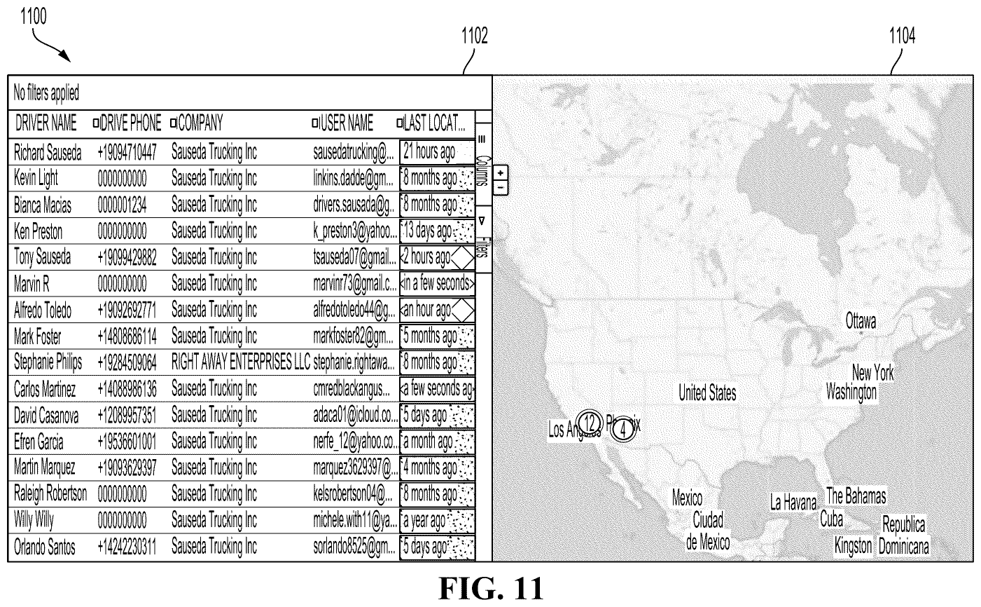

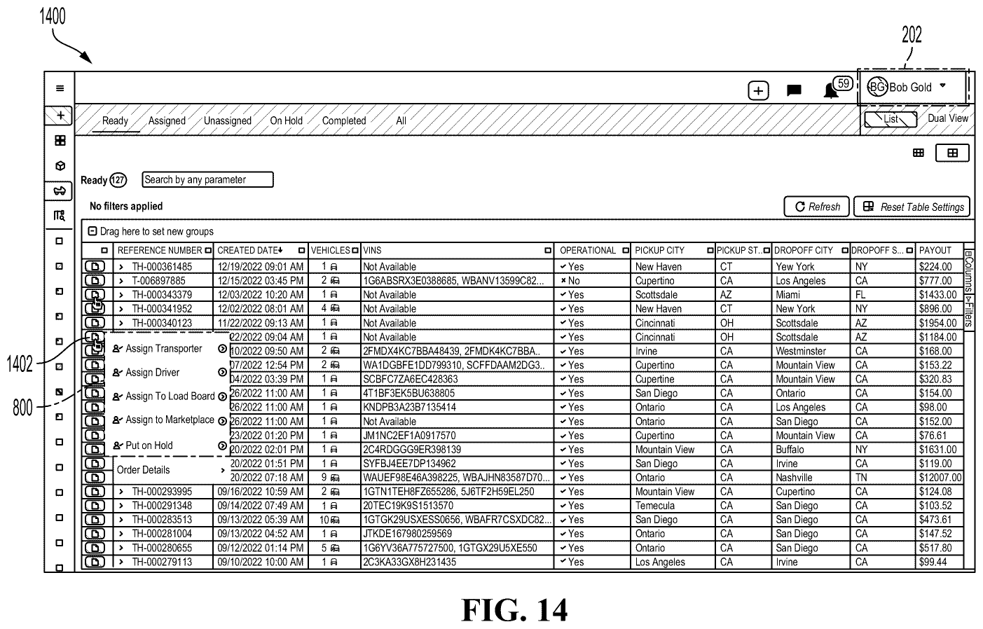

In some examples, the transporter information 204 for the order can include a type of the transporter (e.g., an inhouse transporter, a partner transporter, or an open marketplace transporter), a name of the transporter, and/or any other suitable transporter information about who performs the order and ships load(s) of the order. GUI screens shown in FIGS. 11 and 14 shows the assignment of a transporter (e.g., an inhouse transporter, a partner transporter, or an open marketplace transporter) to an order.

In further examples, the order information 206 can include one or more load identifiers. In some examples, a load identifier can be any suitable indication (e.g., vehicle identification number or any other suitable indication) to identify a load. In some examples, the load identifier is associated with load transportation information (e.g., pickup information (e.g., a pickup location, an estimated pickup time, pickup driver contact information, a pickup note, etc.), drop-off information (e.g., a drop-off location, an estimated drop-off time, drop-off driver contact information, a drop-off note, etc.), a real-time location of the load(s), a distance between the pickup location and the drop-off location, and/or any other suitable information associated with the one or more loads to transport). In other examples, the load identifier can include the load transportation information as well. In further examples, the order information 206 can further include an order status, and/or any other suitable information related to the order. In some examples, the order status can include an available status (e.g., with an assigned driver), an unassigned status (e.g., without an assigned driver), an unclaimed status (e.g., the order before being accepted by the assigned transporter), or any other suitable status. In further examples, the GUI screen 200 can also include preorder information. In some examples, a preorder indicates an order without an assigned transporter. The preorder information can include one or more load identifiers, load transportation information corresponding to the one or more load identifiers (e.g., pickup information (e.g., a pickup location, an estimated pickup time, a pickup note, etc.), drop-off information (e.g., a drop-off location, an estimated drop-off time, a drop-off note, etc.), a distance between the pickup location and the drop-off location), and any other suitable information related to the preorder.

In further examples, the location information 208 can show the pickup location, the drop-off location of the order, and/or a route between the pickup location and the drop-off location on a map. In further examples, the location information 208 can further show a current location of the load(s) and a traveled route of the load(s) on the map. In some examples, the current location of the load(s) can be tracked by a location sensor in a driver computing device 124A1, 124AN, 124N1, 124NN of the transporter 120A, 120N.

In further examples, the status information 210 can show an order timeline and where the order is located in the timeline. For examples, the order timeline can include a timeline bar with several fixed status points (e.g., new order, transporter accept, in transit, delivered, and completed). The order timeline can add or change indications (e.g., times, colors, marks, etc.) for corresponding fixed status points when the order completes transportation operations corresponding to the fixed status points. Thus, the user can easily identify the status of the order.

In further examples, the activity information 212 can show each activity with/without a time of the occurring activity related to the order. For example, the activity information 212 can show when the order is generated, when load(s) is ready for pickup, when the order is output to the transporter or the open marketplace system, when a transportation task message or notification is sent to the user, when load(s) is delivered, when the order is completed, and/or when any other suitable transportation operation is performed.

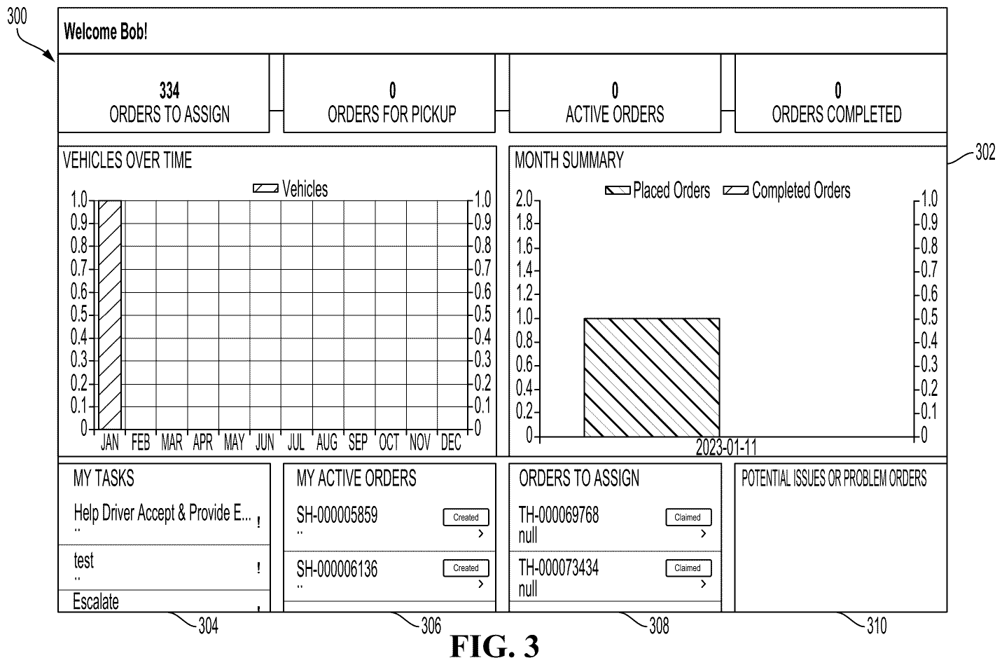

FIG. 3 is an example graphical user interface displaying a dashboard 300 for a TMS. For example, the TMS implemented on the server 110 can generate a GUI screen to be shown on client devices 122, 124 of a transporter 120A, 120N for users via the client devices 122, 124 to see the dashboard 300 for the TMS of the transporter 120A, 120N. In some examples, the dashboard 300 can include any suitable order statistics 302 for a predetermined period of time (e.g., a year, a month, a day, or any other suitable time period). For example, the order statistics 302 can include the numbers of preorders (i.e., orders to assign), orders for pickup, active orders (i.e., orders in transit), orders completed (i.e., orders delivered or disbursed). In further examples, the dashboard 300 can further include any other suitable information on which the user's attention is desirable. For example, the dashboard 300 can further include a list of transportation tasks 304 (e.g., an order creation message, a load grouping message, an order escalation message, a driver assignment escalation message, an order grouping message, or any other suitable transportation tasks), a list of active orders 306, a list of orders to assign 308, and/or a list of potential issues of orders 310.

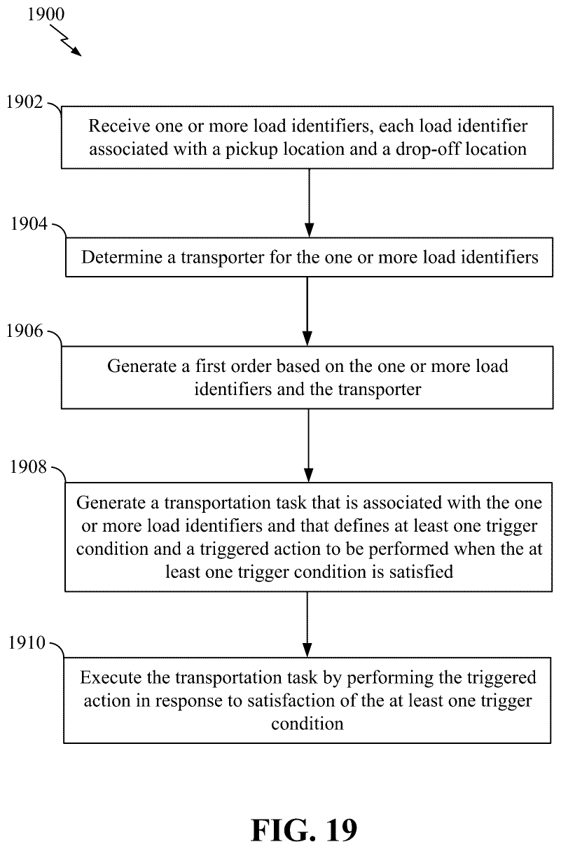

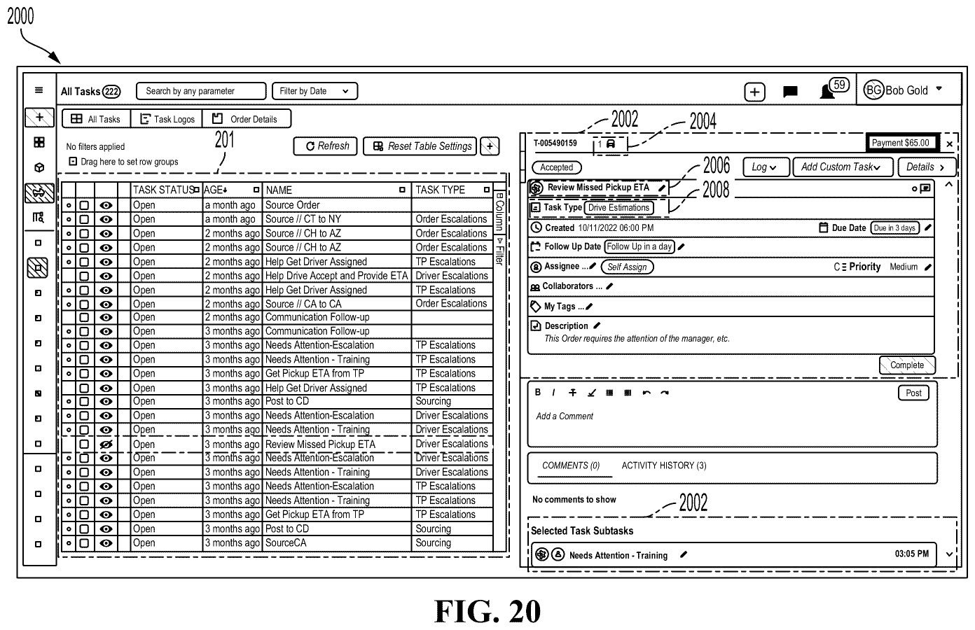

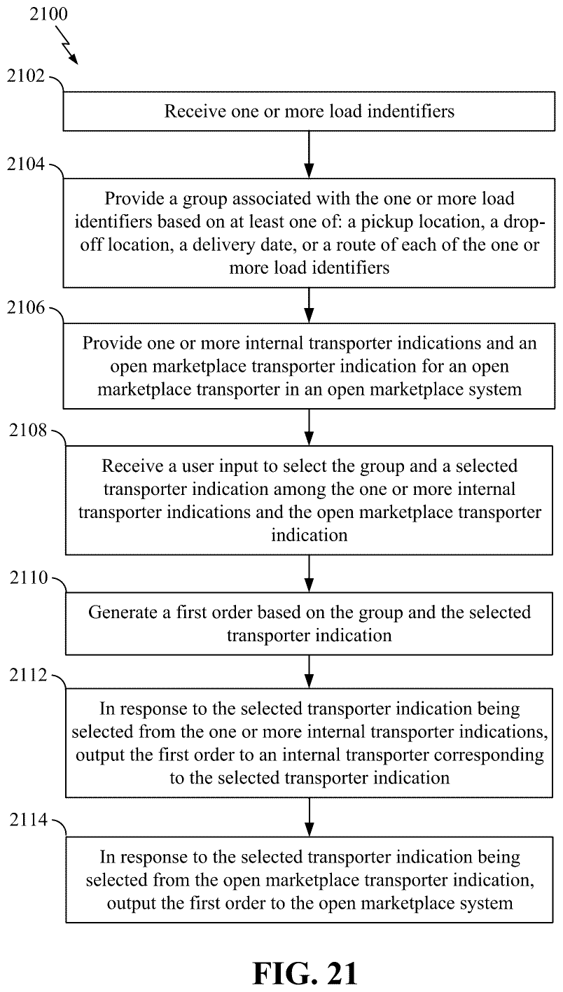

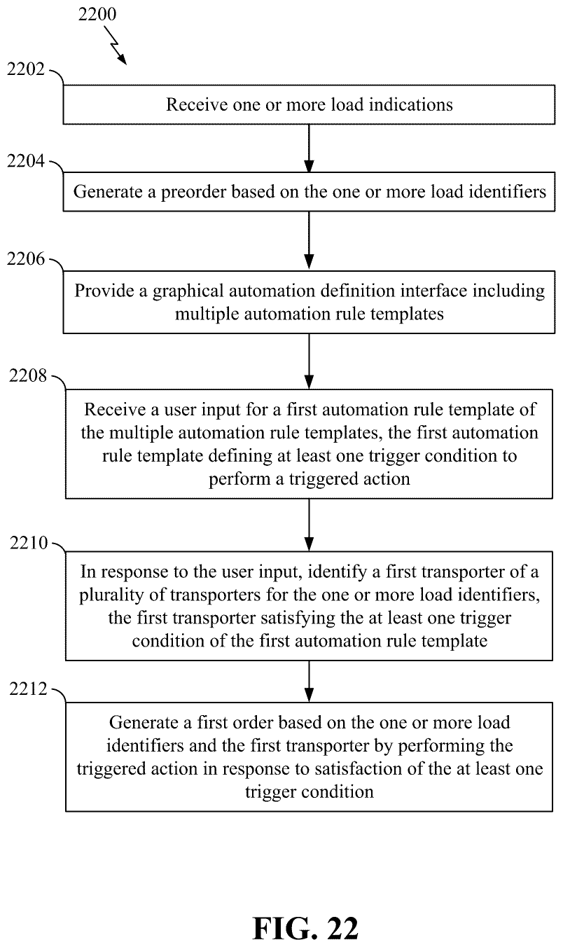

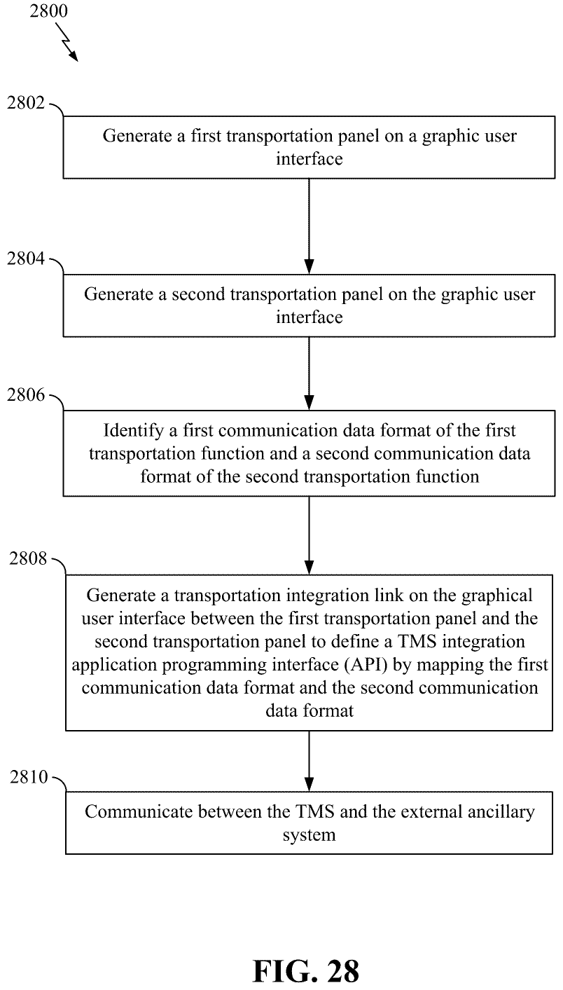

FIGS. 4, 19, 21, 22, and 28 are flowcharts illustrating various example methods and techniques for a TMS. For example, FIGS. 4-18 and corresponding descriptions below illustrate an example method to generate an order and/or a preorder, group order and/or preorders, and/or dynamically display orders in the TMS, which incorporates a heterogeneous TMS (i.e., the open marketplace system) and employ distributed processing or orders using two different transportation management systems. FIGS. 19 and 20 with corresponding descriptions below elaborate an example method to generate and execute one or more configurable and flexible transportation tasks. FIG. 21 elucidates an example method to determine and generate various types of groups based on one or more load identifiers. FIGS. 22-27 illustrate automation of transportation processes. FIGS. 28-30 describes a graphical user interface (GUI)-based TMS integration with an external ancillary system. Additionally, the example graphical user interfaces illustrated in FIGS. 2, 3, 5-18, 20, 25-27 are line drawing versions of respective screenshots of the example graphical user interfaces and, accordingly, FIGS. 2, 3, 5-18, 20, 25-27 may also be described as illustrating screenshots of examples of the TMS.

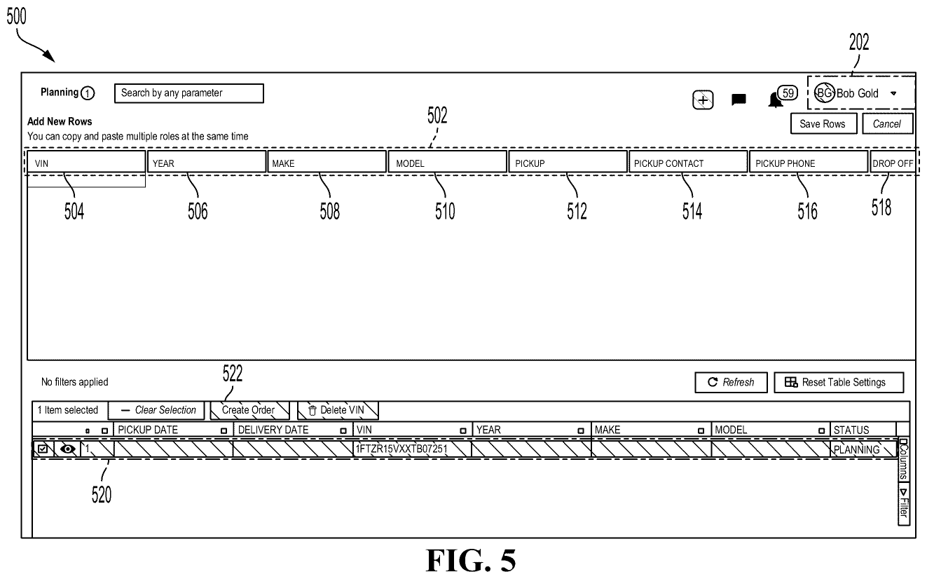

FIG. 4 is a flowchart illustrating an example method and technique for a TMS. The flowchart of FIG. 4 utilizes various system components in the TMS that are described below with reference to FIGS. 5-17. In some examples, the process 400 may be carried out by the server(s) 102 and/or the client device(s) 122, 124 illustrated in FIG. 1, e.g., employing circuitry and/or software configured according to the block diagram illustrated in FIG. 1. In some examples, the process 400 may be carried out by any suitable apparatus or means for carrying out the functions or algorithm described below. Additionally, although the blocks of the process 400 are presented in a sequential manner, in some examples, one or more of the blocks may be performed in a different order than presented, in parallel with another block, or bypassed.

At block 402 of FIG. 4, the server 110 receives one or more load identifiers. In some examples, a load identifier can include a load identification indicator to identify a load. In further examples, the load identifier is associated with a pickup location, and a drop-off location. In further examples, the load identifier can further include load transportation information (e.g., a type (e.g., a make and a model for a car) of the load corresponding to the load identifier, a manufactured year of the load, shipper information, pickup contact information, drop-off contact information, a status of the load identifier, a requested service level, and/or any other suitable information relating to the load to transport corresponding to the load identifier). In some examples, a load corresponding to a load identifier can be a vehicle, a drum, a bag, a pallet, a box, a furniture unit, an appliance unit, an equipment unit, a pre-packaged unit, or the like. In some examples for a car as a load, the load identifier can include a vehicle identification number (VIN). However, the VIN to identify a vehicle can be any other suitable identifier (e.g., a maker, a model, a color, a year, individually or collectively).

In some examples, the server 110 can receive one or more load identifiers via client device(s) 122, 124 for a transporter (e.g., transporter A 120A or transporter N 120N). For example, a user using a client device 122, 124 for the transporter can manually input the one or more load identifiers for corresponding one or more loads to be shipped, and the server 110 can receive the one or more load identifiers. In other examples, when a customer of the transporter wants to ship the one or more loads, the customer can input the one or more load identifiers, and the server 110 can receive the one or more load identifiers. In further examples, a third-party system can transmit the one or load identifiers, and the server 110 can receive the one or more load identifiers.

In some examples shown in FIG. 5, the server 110 can generate a GUI screen 500 to be shown in the client device 122, 124 to receive one or more load identifiers 502. For example, a transportation company uses the TMS implemented in the server 110 with one or more accounts associated with the transportation company and wants to ship one or more cars to a drop-off location. Then, a user 202 (e.g., a customer who wants to ship the one or more cars through the transportation company, a company employee of the transportation company, etc.) for the transportation company can insert, via the GUI screen 500 of the client device 122, 124, the one or more load identifiers 502 (e.g., each load identifier 502 including a vehicle identification number 504 for a car, a year 506 of the car, a make 508 of the car, and/or a model 510 of the car) and/or load transportation information associated with the one or more load identifiers 502 (e.g., a pickup location 512 of the car, a pickup contact person's name 514, a pickup contact number 516, a drop-off contact person's name 518, a drop-off contact number, etc.). Then, the server 110 can receive the one or more load identifiers from the client device(s) 122, 124.

In some examples, the server 110 can generate a preorder based on the one or more load identifiers. In some scenarios, the preorder indicates an order without an assigned transporter. The preorder can include at least one of: a preorder identifier, a preorder generation time, one or more load identifiers and/or associated load transportation information (e.g., a pickup location, an estimated pickup time, a pickup note, a pickup contact person's name, a pickup contact number, a drop-off location, an estimated drop-off time, a drop-off note, a drop-off contact person's name, a drop-off contact number, a distance between the pickup location and the drop-off location), or any other suitable information related to the preorder. In further examples, the one or more load identifiers for the preorder can share at least one of a pickup location, an estimated pickup time, a drop-off location, or an estimated drop-off time.

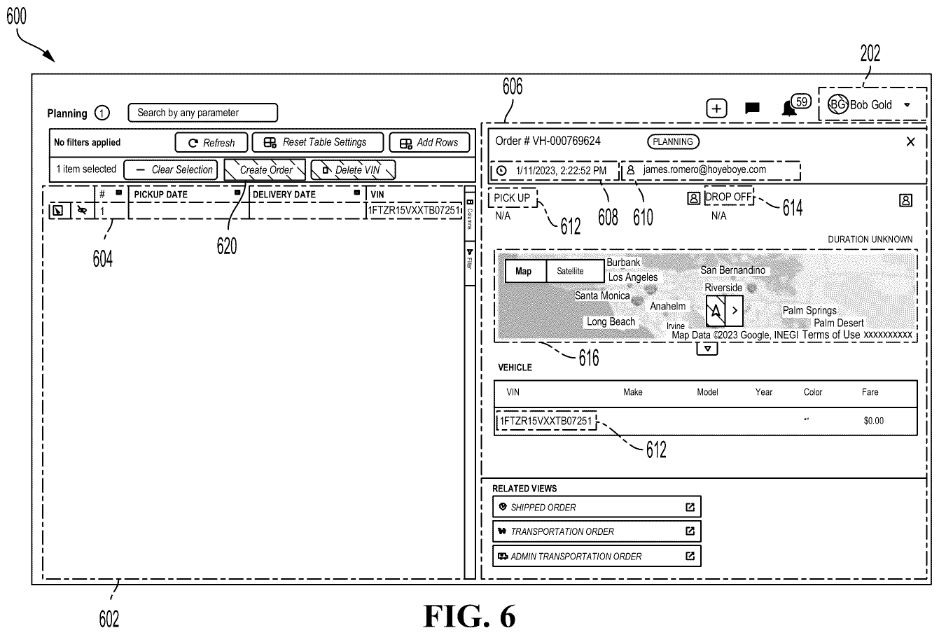

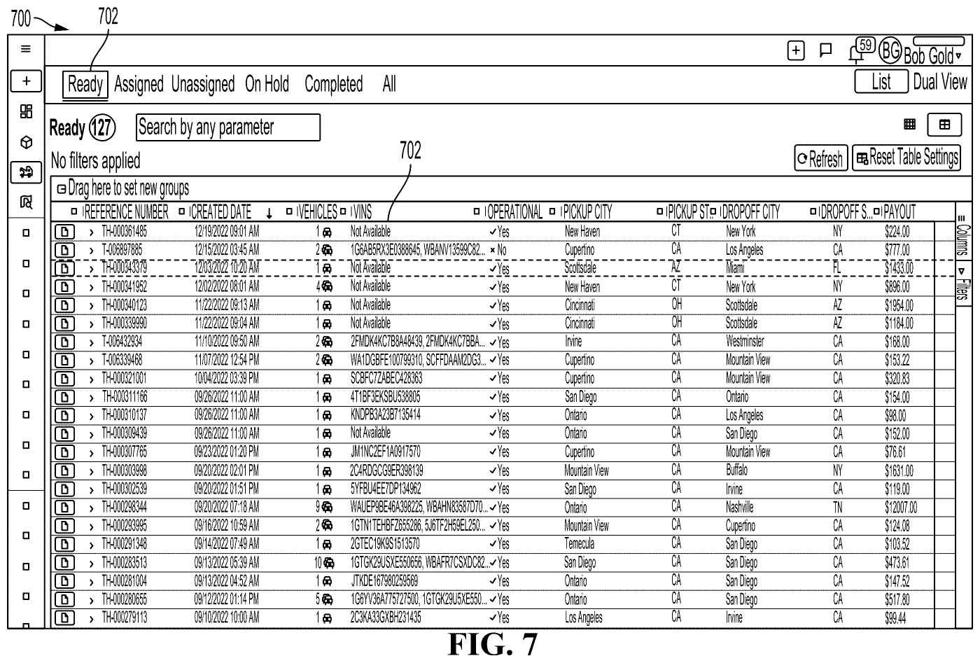

Referring again to FIG. 5, the user 202 via the client device 122, 124 can generate a preorder 520 based on one or more selected load identifiers 520. For example, the GUI screen 500 can have two sections. One section is to generate one or more load identifiers 502, and the other section is to show the generated load identifiers 520 and generate a preorder based the one or more selected load identifiers 520. In some scenarios, the server 110 provides a list of load identifiers on the other section of the GUI screen 500 of the client device 122, 124. Then, the server 110 can generate a preorder in response to the user input 522 to generate the preorder along with the one or more selected load identifiers 520. Referring to FIG. 6, the server 110 can generate a different GUI screen 600 to show a list of load identifiers on a first pane 602 and information of a load identifier 604 on a second pane 606 to generate an order or a preorder. For example, the GUI screen 600 can include a list of load identifiers on the first pane 602 of the GUI screen 600, which is similar to the list of load identifiers 520 in FIG. 5. One or more load identifiers 604 on the first pane 602 can be selected. In some examples, the second pane 606 of the GUI screen 600 can show information about the selected load identifier 604 on the first pane 602 of the GUI screen 600. The information about the selected load identifier 604 can include at least one of: a load reception time 608, contact information 610 (e.g., a customer who ordered the transportation, pickup contact information, drop-off contact information, etc.), a pickup location 612 of the selected load identifier 604, a drop-off location 614 of the selected load identifier 604, a map 616 showing a route between the pickup location and the drop-off location, a vehicle identification number 618 of the load identifier 604, or any other suitable information relating to the load corresponding to the selected load identifier 604. In some examples, the user 202 can select one or more load identifiers 604 on the first pane 602 and provide a user input 620 (e.g., click a generating button) to generate a preorder. Then, the server 110 can generate the preorder in response to the user input 620 to include the one or more selected load identifiers 604. Referring to FIG. 7, the server 110 can generate a GUI screen 700 to display a list of preorders 702. In some examples, a preorder can be considered an order with a ready status 704 without a transporter begin assigned. In some examples, an order can be an unassigned status without an assigned driver for the order or can be an assigned status with an assigned driver.

In further examples, the server 110 can receive one or more other load identifiers and determine a group of the one or more load identifiers and the one or more other load identifiers based on at least one of: a pickup location, a drop-off location, a delivery date, or a route of each of the one or more load identifiers and the one or more other load identifiers. Then, the server 110 can provide the group for the preorder. For example, the server 110 receives vehicle identification number (VIN) A to ship from Chicago to Milwaukee by March 1 and VIN B to ship from Chicago to Milwaukee by March 1. Then, the server 110 can determine a group to combine VIN A and VIN B to ship together and provide a message to generate an order or a preorder based on the group. In further example, the server can determine a group of two or more load identifiers by sharing at least one of: a pickup location, a drop-off location, a delivery date, or a route of each of the one or more load identifiers and the one or more other load identifiers. For example, the server 110 receives VIN A to ship from Indianapolis to Milwaukee (or Chicago) by March 1 and VIN B to ship from Chicago to Milwaukee by March 1. Then, the server 110 can identify that transportation of VIN A shares the route of the transportation of VIN B and can determine a group to combine VIN A and VIN B to ship together and provide a message to generate an order or a preorder based on the group. In further examples, the server 110 receives VIN A to ship from Chicago to Milwaukee by March 1 and VIN B to ship from Chicago to Milwaukee by February 29. Then, the server 110 can determine a group of VIN A and VIN B if VIN A can be transported by February 29 and provide a message to the user 202 to generate an order or a preorder based on the group.

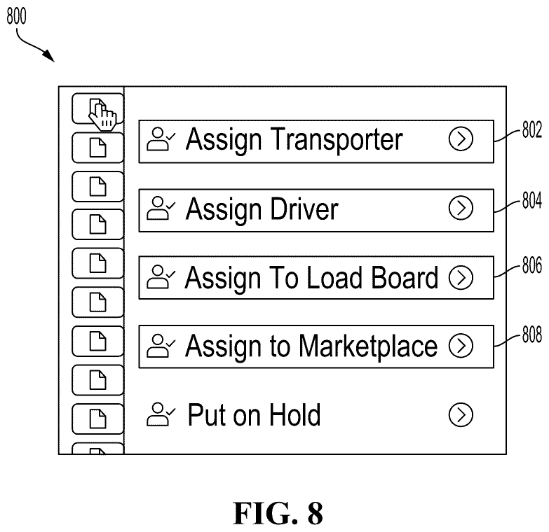

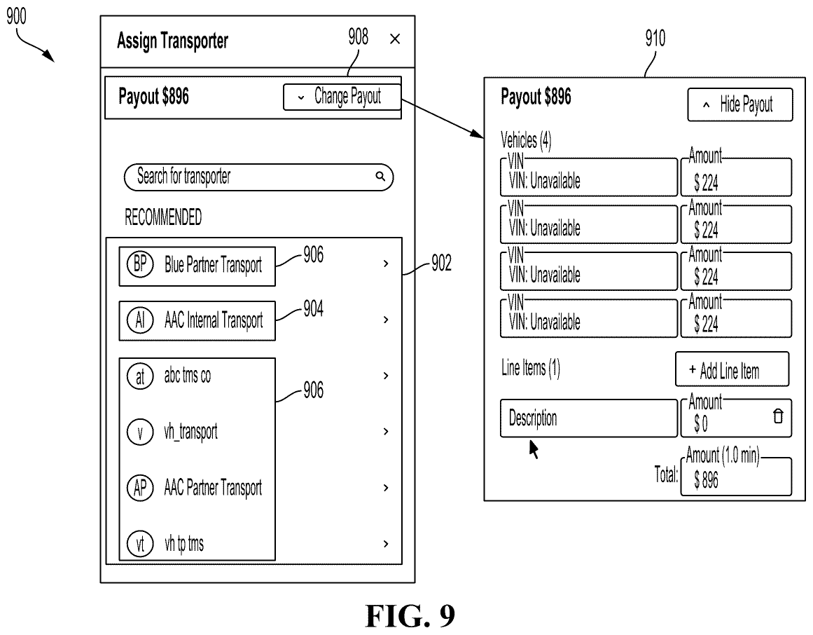

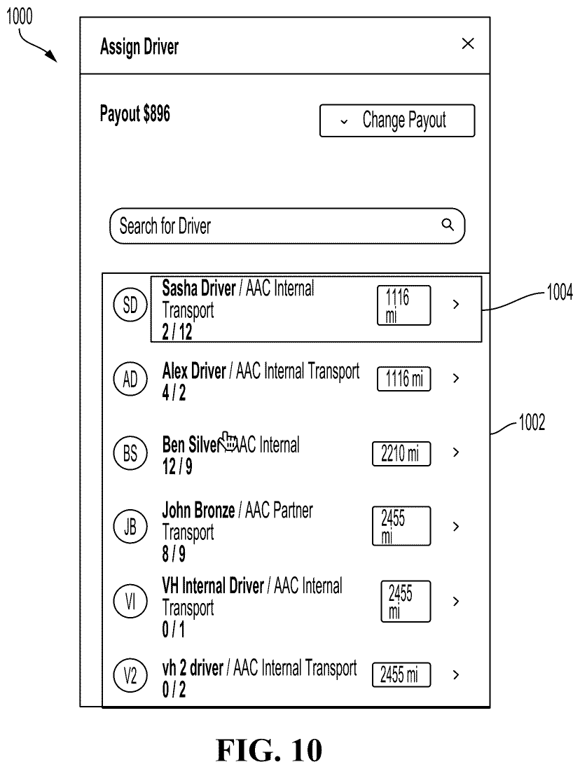

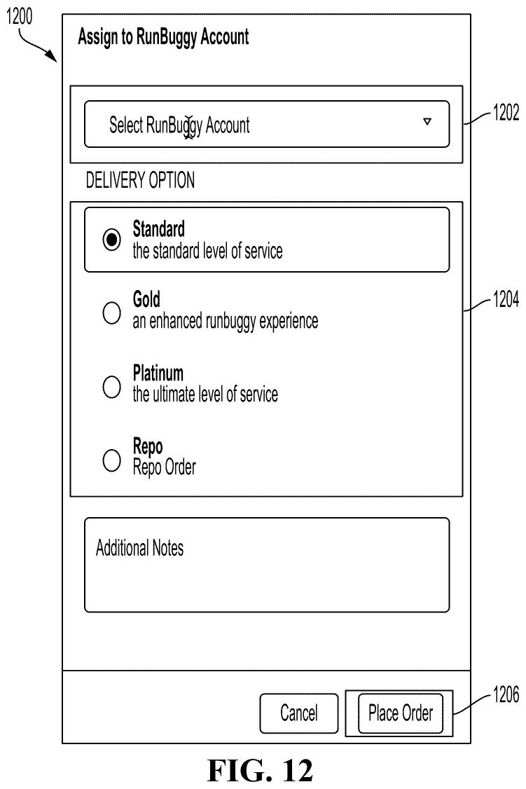

At block 404 of FIG. 4, the server 110 provides one or more internal transporter indications and an open marketplace transporter indication for an open marketplace system. For example, the server 110 generates a GUI screen including the one or more internal transporter indications and the open marketplace transporter indication to be shown in a client device 122, 124. In some examples, the one or more internal transporter indications are included in the database 118 of the server 110. Referring to FIG. 8, the server 110 can generate a GUI screen 800 to provide an internal transporter indication 802 further illustrated in FIG. 9, a driver indication 804 further illustrated in FIGS. 10 and 11, a load board indication 806, or the open marketplace indication 808 further illustrated in FIG. 12. In some examples, an internal transporter corresponding to the internal transporter indication 802, a driver corresponding to the driver indication 804, the load board corresponding to the load board indication 806, or the open marketplace system corresponding to the open marketplace indication 808 can be assigned in connection with the one or more load identifiers.

In some examples, the one or more internal transporter indications is indicative of an inhouse transporter or one or more partner transporters. In some examples, the inhouse transporter indicates a transporter having internal fleet vehicle(s) owned by the transportation company, which uses the TMS to manage the preorder(s) and/or the order(s). In further examples, a partner transporter is a transporter having external fleet vehicle(s) owned by a third-party transportation company, which uses the TMS. In some examples, the inhouse transporter and the partner transporters use the same TMS with different accounts. Thus, the inhouse transporter can share statuses of orders of the inhouse transporter with the one or more partner transporters within the same TMS. In some examples, the server 110 determines the one or more partner transporters among multiple partner transporters based on at least one of: a pickup location of the one or more load identifiers, a drop-off location of the one or more load identifiers, or a usage indication of the one or more partner transporters. In further examples, the server 110 can determine the one or more partner transporters among multiple partner transporters based further on reputation ranks, a number of timely deliveries, a number of timely placed on pickup locations and order progression, background/document checks, and avoiding fraudulent behavior of the one or more partner transporters.

Referring again to FIGS. 8 and 9, when the user selects the internal transporter indication 802 in FIG. 8, the server 110 can generate a GUI screen 900 in FIG. 9 to provide one or more internal transporter indications 902. The one or more internal transporter indications 902 can include the inhouse transporter indication 904 and the partner transporter indications 906. In some examples, the server 110 can determine the order and the list of the internal transporter indications 902 to be shown on the GUI screen 900 based on availability of a fleet vehicle for the internal transporter. For example, the server 110 can show the list of the internal transporter indications 902 when the fleet vehicles of the internal transporters corresponding to the internal transporter indications 902 are available on the pickup time, the drop-off time, the pickup location, and/or the drop-off location for the one or more load identifiers.

In further examples, the server 110 can determine the order and the list of the internal transporter indications 902 based on how often the transportation company uses the internal transporters corresponding to the internal transporter indications 902. For example, when the transportation company used the inhouse transporter 15 times, partner transporter A 20 times, partner transporter B 5 times, and partner transporter C 1 times, the server 110 can determine the list of internal transporter indications 902 (the inhouse transporter, partner transporter A, and partner transporter B) when the transportation company uses an internal transporter more than a predetermined number of usage (e.g., 1, 5, or any other suitable threshold number of usage). Also, the server can determine the order of the list of the internal transporter indications 902 (e.g., partner transporter A, the inhouse transporter, and partner transporter B) based on the number of usage.

In further examples, the server 110 can also consider a period of time. For example, the server 110 can determine the order and the list of the internal transporter indications 902 based on how often the transportation company uses the internal transporters for the last one year. Thus, in the examples above, when the transportation company has not used partner transporter A for last five years, the server 110 can exclude partner transporter A in the list of the internal transporter indications 902. In further examples, the server 110 can determine the order and the list of the internal transporter indications 902 based on costs. In the examples above, when the cost to ship the one or more loads using transporter B is less expensive than that using other transporters, the server 110 can show transporter B at the top of the list of the internal transporter indication 902. In some examples, the server 110 can determine the cost 908 based on at least one of: a specific contracted price between the transportation company and the respective transporter, previous price data of the respective transporter, a standard price, or any other suitable factor. The GUI screen 900 can show the detail cost 910 to ship the one or more loads. In some examples, the cost 910 can be manually adjusted by the user.

In further examples, the server 110 can determine the order and the list of the internal transporter indications 902 based on reputation ranks or rates of the internal transporters corresponding to the internal transporter indications 902. For example, a rate of an internal transporter can be determined based on inspections, estimated time arrivals, timely delivery and order progression, background/document checks, avoiding fraudulent behavior, and/or any other suitable objective or subjective criteria.

Referring again to FIGS. 8 and 10, when the user selects the driver indication 804 in FIG. 8, the server 110 can generate a GUI screen 1000 in FIG. 10 to provide one or more driver indications 1002. In some examples, the assignment of a driver can include assignment of a transporter because each driver is associated with a transporter. In some examples, the server 110 can determine the order and the list of the driver indications 1002 to be shown on the GUI screen 1000 (e.g. based on the distance between the pickup location and the driver location, the corresponding internal transporters, or any other suitable conditions). In some example, the driver location can be determined based on a location sensor of a driver computing device 124A1, 124AN and be provided on the GUI screen 1000. Thus, in some examples, the list of driver indications 1002 can include driver information 1004 including the name of the drivers, the transporters associated with the corresponding the drivers, the distances between the pickup location and the driver locations corresponding to the drivers, and/or any other suitable driver information. In referring to FIG. 11, the server 110 can generate a different GUI screen 1100 to provide driver information for the one or more driver indications 1002 along with the locations of the drivers on a map 1104.

In further examples, the server 110 can determine the order and the list of the driver indications 1002 based on reputation ranks or rates of the drivers corresponding to the driver indications 1002. For example, a rate of an internal transporter can be determined based on inspections, estimated time arrivals, timely delivery and order progression, background/document checks, avoiding fraudulent behavior, and/or any other suitable objective or subjective criteria. In some examples, the rates of the drivers and transporters provide the mechanism, which connects shipper expectations to the price the consumers pay to the expected quality of service based on the rates about drivers and transporters.

Referring again to FIGS. 8 and 12, when the user selects the open marketplace indication 808 in FIG. 8, the server 110 can generate a GUI screen 1200 in FIG. 12 to use an open marketplace transporter through the open marketplace system. The open marketplace system is a TMS to connect shippers to transporters. The open marketplace system is a logically and/or physically separate system from the TMS implemented in the server 110. For example, the transportation company using the TMS can have one or more separate accounts 1202 for the open marketplace system. In some examples, the server 110 can access the open marketplace system using an open marketplace system account 1202 with or without an option 1204 to place an order 1206 in the open marketplace system. Thus, the server 110 provides the one or more load identifiers with/without an option to the open marketplace system to place an order in the open marketplace system. In some examples, the option can include the level of service (e.g., standard, gold, platinum, etc.) to provide different levels of communication and assistance expected for transportation. However, it should be appreciated that the option can be any other suitable condition or option to generate a transport order in the open marketplace system. In some examples, the server 110 can receive a status of the order generated in the open marketplace system and update the status of the order in the TMS. Thus, the server 110 can process multiple orders with distributed computing for the server 110 and the open marketplace system and reduce system resource usage in the server 110 due to the distributed computing. In some examples, the server 110 might not select and/or control an open marketplace transporter of the open marketplace system. In further examples, the server 110 can provide conditions using the options to select and/or control an open marketplace transporter of the open marketplace system. In other examples, the server 110 can receive a list of open marketplace transporters and select an open marketplace transporter.

At block 406 of FIG. 4, the server 110 receives a user input to select a selected transporter indication among the one or more internal transporter indications and the open marketplace transporter indication. For example, the user can select the inhouse transporter, a partner transporter, or an open marketplace transporter of the open marketplace system to transport the one or more loads corresponding to the one or more load identifiers. In some examples, the user input can include a mouse click on the selected transporter indication, a keyboard input, a screen touch input, a voice command input, or any other suitable input to select the selected transporter indication. In some examples, referring again to FIG. 8, the user input can include selecting the internal transporter indication 802 to select the inhouse transporter or a partner transporter or the open marketplace indication 808 to use an open marketplace transporter of the open marketplace system. In further examples, referring again to FIG. 9, the user input can further include selecting the internal transporter (inhouse) indication 904 or a partner transporter indication 906. In further examples, referring again to FIG. 10, the user input can further include selecting a driver 1004 who is associated with a transporter. Thus, the user input can select a selected transporter indication by selecting the driver 1004.

At block 408 of FIG. 4, the server 110 generates a first order based on the one or more load identifiers and the selected transporter indications. In some examples, an order indicates a transport order with a transporter and/or a driver being assigned. In further examples, an order indicates a transport order claimed and assigned with a transporter and/or a driver. In further examples, an order indicates a transport order which a transporter and/or a driver accepted to transport one or more loads corresponding to the one or more load identifiers in the order. In further examples, an order with an unclaimed status indicates a transport order which a transporter and/or a driver has not accepted to transport one or more loads corresponding to the one or more load identifiers in the order. In some examples, an order can include at least one of: one or more load identifiers (each including a load identification indicator (e.g., vehicle identification number), a pickup location, a drop-off location, a type (e.g., a make and a model for a car) of the load corresponding to the load identification indicator, a manufactured year of the load, shipper information, pickup contact information, drop-off contact information, a status associated with the load identifier), an order pickup location, an order drop-off location, a distance between the order pickup location and the order drop-off location, transporter information (e.g., a selected transporter (inhouse transporter, partner transporter, or an open marketplace transporter)), driver information (e.g., a driver name, driver contact information, etc.), an order generation time, an order status, or any other suitable information. In some examples, an order can include one or more field values from the one or more load identifiers to be shipped, one or more field values from the preorder, and/or additional order-related information (e.g., the order creation date, the transporter information, the driver information, the order status, or any other suitable order information).

In some examples, an order is in one of various statuses. For example, the order can be in a transporter-claimed status (i.e., the order when the transporter accepted to transport the loads), a transporter-unclaimed status (i.e., the order when the transporter has not accepted to transport the loads), a driver-unassigned status (i.e., the order before a driver is assigned to the order), a driver-assigned status (i.e., the order when a driver is assigned to the order), a driver-accepted status (i.e., the order when a driver accepts the order), an in-transit status (i.e., the order after the departure of the loads before the arrival of the loads), an arrival status (i.e., the order when the loads arrives at the drop-off location), an on-hold status, and/or a complete status (e.g., the order when the server 110 receives a complete message from a person who receive the loads, the order when the server 110 receives a fare for the delivery of the loads, etc.).

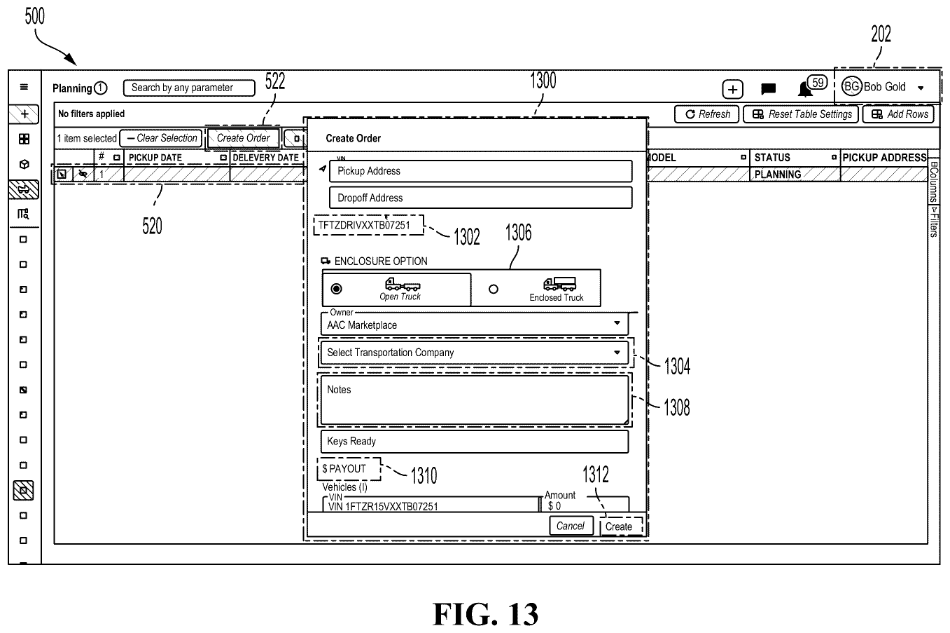

For example, referring to FIG. 13, the server 110 can generate a GUI screen 1300 to generate the first order. In some examples, the server 110 can generate the first order on the GUI screen 1300 based on one or more load identifiers in the GUI screen 500. For example, the user 202 can select the one or more load identifiers 520 and provide an input to generate an order for the selected load identifiers 520. Then, in response to the input, the server 110 generates the GUI screen 1300 to generate an order. The GUI screen 1300 can include the selected one or more load identifiers 1302 and a selection indication 1304 to show a selected transporter indication, which is selected among the one or more internal transporter indications and the open marketplace transporter indication, described in connection with FIGS. 8-12. The selected transporter indication corresponds to a transporter to transport the one or more loads corresponding to the selected one or more load identifiers 1302. In further examples, the GUI screen 1300 can further include a type of truck 1306 to transport the one or more loads, a message 1308 to the transporter, a payout amount 1310, and/or any other suitable information/input for a new transport order. Then, the user 202 can provide a user input 1312 (e.g., click an order creation button) to generate an order. Based on the one or more selected load identifiers, the selected transporter, and/or information provided by the user, the server 110 generate an order.

In further examples, the server 110 can assign the selected transporter indication to the preorder to generate the first order. Referring to FIG. 14, the server 110 can generate a GUI screen 800 to assign the selected transporter indication to the preorder to generate the first order in a GUI screen 1400 to show a list of preorders. In some examples, the server can generate the GUI screen 800 associated with FIG. 8 assign the selected transporter indication to the preorder. For example, the user 202 can select a preorder 1402 among the list of preorders shown in the GUI screen 1500. Then, the server 110 can generate the GUI screen 800 in response to the user input to select the preorder 1402. By assigning the selected transporter (e.g., described in connection with FIGS. 9-12) to the preorder 1402, the server 110 generates an order based on the preorder with the selected transporter.

In further examples, the server 110 can receive one or more other load identifiers and determine a group of the one or more load identifiers and the one or more other load identifiers based on at least one of: a pickup location, a drop-off location, a delivery date, or a route associated with each of the one or more load identifiers and the one or more other load identifiers. Then, the server 110 can provide the group for the first order. Referring again to FIG. 14, the server 110 can identify commonality of the load identifiers shown in the GUI screen 1400. For example, some load identifiers can be associated with at least one of: the same pickup location, the same drop-off location, the same delivery date, or the same route of the load identifiers. Then, the server 110 can determine a group of the load identifiers based on the commonality and provide a message to the user 202 indicating that an order can be generated based on the group. In further examples, the server 110 can determine a group of the one or more load identifiers and the one or more other load identifiers additionally or alternatively based on at least one of: a type of the loads, a truck type, or a requested service level. For example, the server 110 can determine the group by whether the type (e.g., an enclosed trailer, open trailer, oversized truck, tow hitch enabled truck, etc.) of the truck for the one or more load identifiers is the same as the other type of truck for the one or more other load identifiers. In addition, the server 110 can determine the group by whether the requested service level of transportation for the one or more load identifiers is equivalent to the other requested service level of transportation for the one or more other load identifiers. For example, the server 110 orders might not determine a group of orders requested with different levels of communication and assistance.

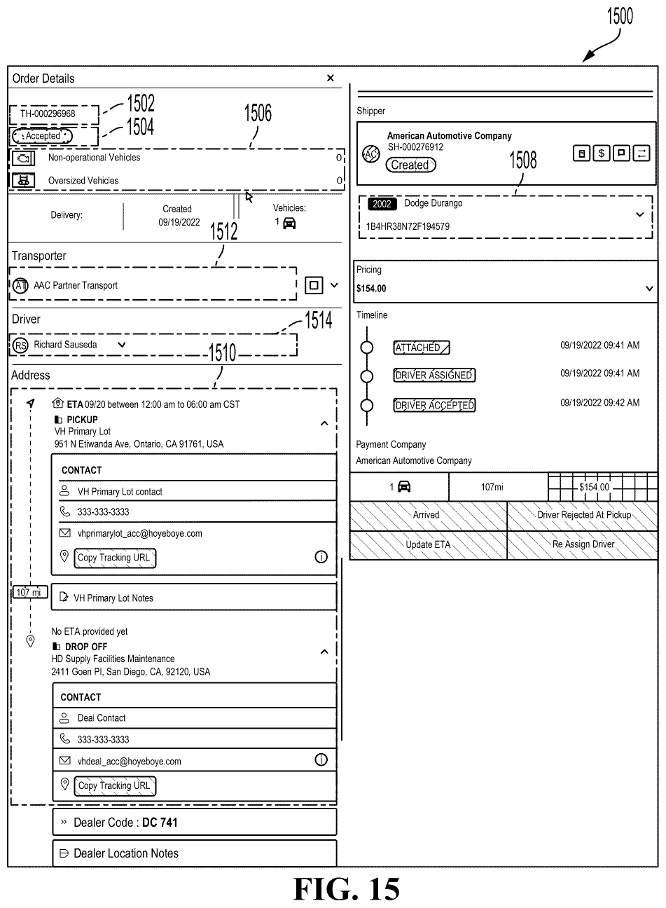

In some examples as shown in FIG. 15, the server 110 can generate a GUI screen 1500 to provide information of the first order. For example, the GUI screen 1500 can indicate that the first order with an order indicator 1502 has a status 1504 (e.g., driver-accepted status where the driver accepted the order to transport the load(s)). In further examples, the GUI screen 1500 can further provide load identifier(s) (e.g., load identification indicator(s), the type of the load(s), etc.). In further examples, the GUI screen 1500 can further show the transportation information 1510 (e.g., an order pickup location, an estimated order pickup time, pickup contact information, an order drop-off location, an estimated order drop-off time, drop-off contact information, a distance between the order pickup location and the order drop-off location, etc.), transporter information 1512 (e.g., type of the transporter (inhouse transporter, a partner transporter, or an open marketplace transporter), a name of the transporter, and/or any other suitable information), and/or driver information 1514 (e.g., a name of the driver, contact information, etc.). In further examples, the server 110 can update the order using the GUI screen 1500 (e.g., reassigning a driver, reassigning a transporter, updating the order pickup location, updating the order drop-off location, updating an estimated time to pick up load(s), updating an estimated time to drop off load(s), and/or any other information of the order).

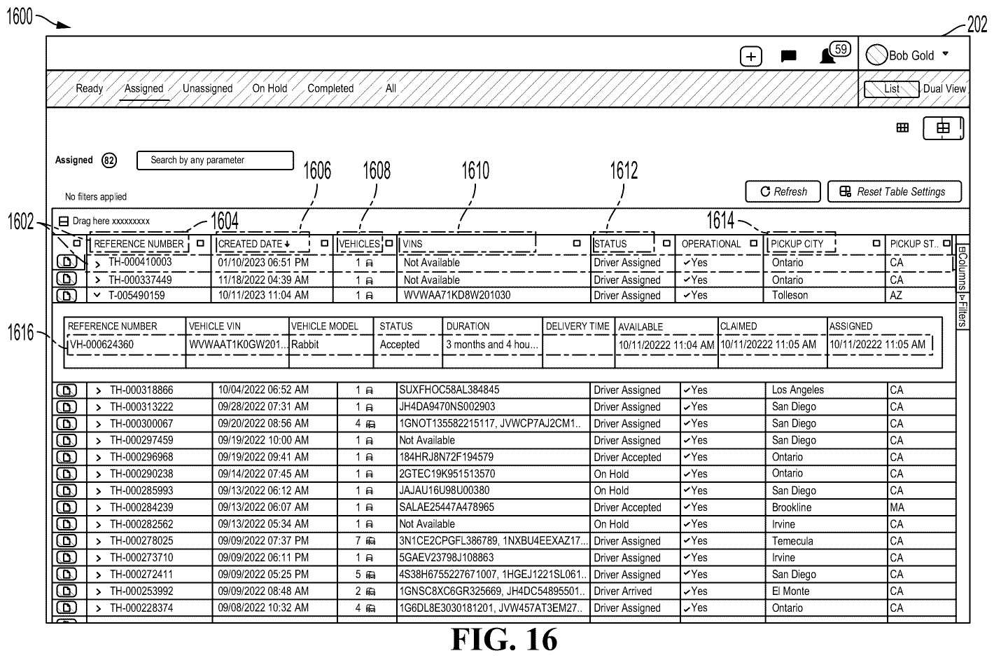

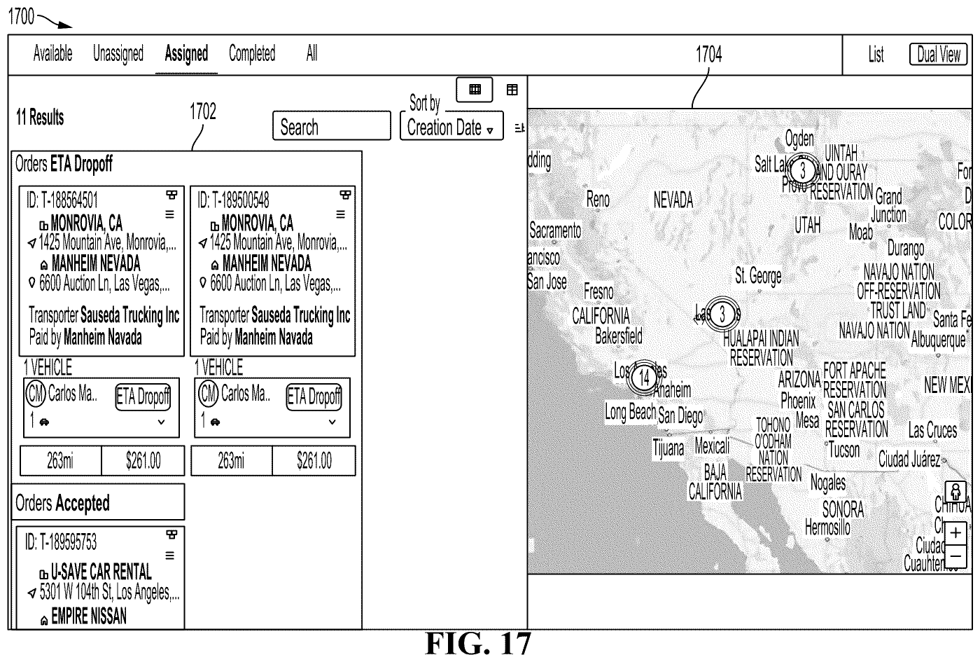

In some examples as shown in FIG. 16, the server 110 can generate a GUI screen 1600 to provide a list of orders. In some examples, each order 1602 on the GUI screen 1600 can show the order indicator 1604 (e.g., reference number), an order creation date 1606, a number of loads 1608 to ship, load identifier(s) 1610, an order status 1612, an order pickup location 1614, a drop-off location, etc. In some examples, when the user 202 select an order in the list of orders, the server provide further information 1616 about the order (e.g., load identifier(s), the time to be available, time to be claimed, time to be assigned, etc.). In further examples as shown in FIG. 17, the server 110 can generate another GUI screen 1700 to provide a list of orders 1702 with a map 1704 showing the locations in the orders.

In some examples, the server 110 can generate a second order based on one or more other load identifiers and can combine the first order and the second order based on at least one of: a pickup location, a drop-off location, a delivery date, a status indication, or a route from the pickup location to the drop-off location of each of the first order and the second order. Referring again to FIG. 16, the server 110 can identify commonality of the orders shown in the GUI screen 1600. For example, some orders can have at least one of: the same pickup location, the same drop-off location, the same delivery date, or the same route associated with the load identifiers. Then, the server 110 can determine a group of the orders based on the commonality and provide a message to the user 202 indicating that the orders can be combined based on the group.

In some examples, the server 110 can generates multiple other orders for the inhouse transporter, the one or more partner transporters, and an open marketplace transporter of the open marketplace system. The server 110 can dynamically access an internal database (i.e., the database 118 of the server 110) for a first subset of the other orders for the inhouse transporter to obtain a first status of the first subset of the other orders. The server 110 can dynamically access the internal database for a second subset of the other orders for the one or more partner transporters to obtain a second status of the first subset of the other orders. The server 110 can dynamically obtain a third status of a third subset of the other orders for the open marketplace transporter from the open marketplace system. Then, as shown in FIG. 16, the server 110 can provide or display a first status of the first subset of the other orders, a second status of the second subset of the other orders, and a third status of the third subset of the other orders. Thus, the server 110 can provide or display multiple different orders for inhouse transporter, partner transporters, and open marketplace transporters on the same GUI screen 1600.

At block 410, the server 110 outputs the first order to an internal transporter corresponding to the selected transporter indication in response to the selected transporter indication being selected from the one or more internal transporter indication. For example, to output the order in block 410, the server 110 may transmit the first order via the communication network 140 to a transporter selected from transporter A 120A to transporter N 120N. In some examples, to output the first order to the internal transporter, the server 110 outputs the first order to a driver of the internal transporter (e.g., for receipt and display on a graphical user interface of a driver's laptop, smartphone, or other computing device). In some examples, the first order can be output to the internal transporter, and the internal transporter determines a driver to ship the one or more loads and provide the driver information to the transportation company. In other examples, the first order can be output to the assigned driver of the internal transporter. In further examples, the internal transporter and/or the driver might not accept the first order to transport the one or more loads corresponding to the one or more load identifiers. Then, the user can reassign another transporter to the order. In other examples, outputting the first order to the internal transporter can include outputting the first order, which the internal transporter accepted, to the internal transporter.

In some examples, when the selected transporter indication is indicative of a first partner transporter of the one or more partner transporters, the server 110 can share the first order with the first partner transporter. For example, when a driver of a partner transporter (e.g., transporter N 120N) transports loads for the transportation company (e.g., transporter A 120A), the driver, via a driver computing device 124N1, 124NN, can update the status of the order in the TMS with a partner transporter account in the database 118 of the server 110. Then, the transportation company 120A can access the status of the order updated by the driver of the partner transporter in the database 118. In other examples, when a driver of a partner transporter (e.g., transporter N 120N) transports loads for the transportation company (e.g., transporter A 120A), the driver, via a driver computing device 124N1, 124NN, can directly update the status of the order in the TMS with the transportation company's account in the database 118 of the server 110. Then, the transportation company 120A can identify the status of the order updated by the driver of the partner transporter in the database 118.

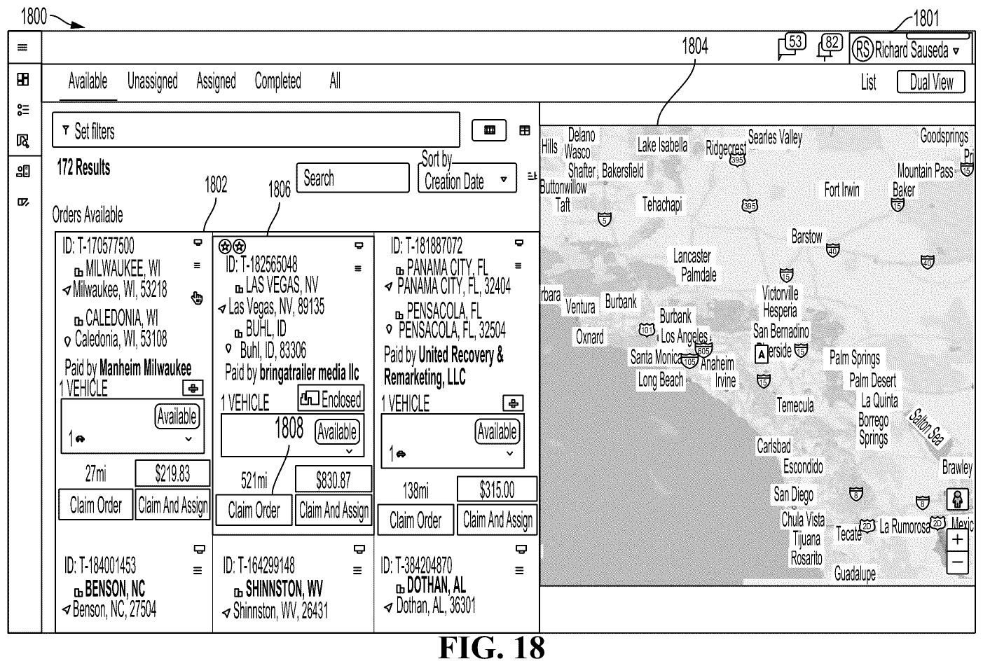

In some examples, FIG. 18 shows a graphical user interface for a transporter 1801 (e.g., a client device 122, 124 for a partner transporter or an inhouse transporter) to claim an order. For example, the transporter 1801 and the user 202 can use the same TMS system. In some examples, the server 110 can generate an order for the user 202 by assigning a transporter 1801 to a preorder. However, the order might not be effective or ready until the transporter claims the order, which indicates that the transporter 1801 accepts the order. In some examples, when the transporter is assigned to a preorder, the server 110 can transmit the order to the transporter 1801. In some examples, the server can provide a GUI screen 1800 to the transporter 1801 where the GUI screen 1800 provide one or more orders 1802 which the transporter has not claimed and a map 1804 showing pickup and drop-off locations of the one or more orders 1802. By the transporter's input 1808 (e.g., claim the order), the server 110 can indicate that the order 1806 is ready or effective because the assigned transporter 1801 accepted the order. In some examples, the transporter's order claim, the order can be in an intermediate status (e.g., an unassigned status). In the unassigned status of the order, the transporter 1801 or the user 202 can assign a driver of the transporter to the order. After assigning a driver to the order, the order can be in a ready or effective status.

At block 412, the server 110 outputs the first order to the open marketplace system in response to the selected transporter indication being selected from the open marketplace transporter indication. For example, to output the order in block 412, the server 110 may transmit the first order via the communication network 140 to the open marketplace system 130. In some examples, in response to the selected transporter indication being selected from the open marketplace transporter indication, the server 110 can obtain a status of the first order from the open marketplace system. In other examples, the server 110 can access the open marketplace system to obtain the status of the first order. In further examples, the status of the first order can include an order creation indication from the open marketplace system. For example, when the server 110 output the first order to the open marketplace system, the open marketplace system receives the first order as a request to generate an open marketplace order. When the open marketplace system generates the open marketplace order with an open marketplace transporter, the open marketplace system transmits an order creation indication indicating that the open marketplace order has been successfully generated. Then, the server 110 can receive the order creation indication and update the status of the order in the database 118. In some examples, when the status of the open marketplace order changes, the server 110 can receive an updated status of the open marketplace order from the open marketplace system. In further examples, the server 110 can request an updated status of the open marketplace order and update the status of the order based on the updated status of the open marketplace order from the open marketplace system.

Accordingly, after the first order is provided to the open marketplace system 130 and the first order is created on the open marketplace, transporters on the open marketplace may accept the first order. The acceptance can be communicated back to the server 110 via the communication network 140 and displayed to the user. Similarly, the open marketplace system 130 can communicate status updates on the accepted order through completion of the transport (e.g., indicating pickup, location during transit, completed delivery, etc.).

Accordingly, at least via this method of FIG. 4, the TMS system implemented by the server 110 bridges disparate software systems and transport databases or resources, and provides a TMS system with access to and communication with an open marketplace system 130 that may otherwise be isolated from the TMS system.

FIG. 19 is a flowchart illustrating an example method and technique for task generation and execution in a TMS. The flowchart of FIG. 19 utilizes various system components in the TMS that are described below with reference to FIG. 20. In some examples, the process 1900 may be carried out by the server(s) 102 and/or the client device(s) 122, 124 illustrated in FIG. 1, e.g., employing circuitry and/or software configured according to the block diagram illustrated in FIG. 1. In some examples, the process 1900 may be carried out by any suitable apparatus or means for carrying out the functions or algorithm described below. Additionally, although the blocks of the process 1900 are presented in a sequential manner, in some examples, one or more of the blocks may be performed in a different order than presented, in parallel with another block, or bypassed.

At block 1902, a server (e.g., one or more server(s) 110, also referred to as the server 110) receives one or more load identifiers. In some examples, each load identifier is associated with a pickup location and a drop-off location. In some examples, block 1902 is substantially similar to block 402 of FIG. 4.

At block 1904, the server 110 determines a transporter for the one or more load identifiers. In some examples, block 1904 is substantially similar to blocks 404 and 406 of FIG. 4. For example, to determine the transporter, the server 110 can provide one or more internal transporter indications and an open marketplace transporter indication for an open marketplace system, receive a user input to select a selected transporter indication among the one or more internal transporter indications and the open marketplace transporter indication, assign an internal transporter corresponding to the selected transporter indication as the transporter in response to the selected transporter indication being selected from the one or more internal transporter indications, and output the first order to the open marketplace system and assigning an external transporter identified via the open marketplace system as the transporter in response to the selected transporter indication being selected from the open marketplace transporter indication.

At block 1906, the server 110 generates a first order based on the one or more load identifiers and the transporter. In some examples, block 1906 is substantially similar to block 408 of FIG. 4.

At block 1908, the server 110 generates a transportation task that is associated with the one or more load identifiers and that defines at least one trigger condition and a triggered action to be performed when the at least one trigger condition is satisfied. For example, the server 110 may generate the transportation task based on user input received from a client device (e.g., 122A, 122N) via a graphical user interface, such as illustrated and described with respect to FIG. 20, below. Additionally, the server 110 may provide for several types of transportation tasks. Examples of types of transportation tasks include a load task, a transport task, a preorder, and an order task. Further description of generating a transportation task and types of tasks are provided below.

At block 1910, the server 110 executes the transportation task by performing the triggered action in response to satisfaction of the at least one trigger condition. Additional description of executing a transportation task is provided below.

In some examples, the transportation task is a load task. For example, the at least one trigger condition includes an elapsing of a first predetermined time period after receiving the one or more load identifiers, and the triggered action includes providing an order creation message. Then, to execute the load task, the server 110 can provide the order creation message in response to the elapsing of the first predetermined time period after receiving the one or more load identifiers. For example, when the server 110 has not received a user input or any suitable command to generate an order for the one or more load identifiers for a predetermined time period after the server 110 received the one or more load identifiers, the server 110 can generate and execute a load task to provide an order creation message to the user for the transportation company to create an order for the one or more load identifiers.

In further examples, the transportation task is another load task. The at least one trigger condition includes determining each load identifier of the one or more other load identifiers is associated with the pickup location, the pickup time, the drop-off location, the drop-off time, the requested service level, and/or the types of the loads of the one or more load identifiers, and the triggered action includes providing a load grouping message. Then, to execute the load task, the server 110 can generate the load grouping message in response to determining that the one or more other load identifiers are associated with the pickup location and the drop-off location. For example, the server 110 can identify the trigger condition indicating that the load identifiers have the same pickup location, the same drop-off location, the same or similar pickup time, the same or similar drop-off time, and/or a shared route between the load identifiers. Then, when the server 110 can determines that the trigger condition has been met, the server 110 can generate and execute a load task to provide a load grouping message to the user for the transportation company to group the one or more load identifiers.

In further examples, the transportation task is a transport task. For example, the at least one trigger condition includes providing one or more internal transporter indications and an open marketplace transporter indication for an open marketplace system, and the triggered action includes one or both of: generating a fare message for the one or more internal transporter indications and the open marketplace transporter indication, or generating a reputation message for the one or more internal transporter indications and the open marketplace transporter indication. To execute the transporter task, in response to providing the one or more internal transporter indications and the open marketplace transporter indication, the server 110 can perform one or both of: generating a fare message for the one or more internal transporter indications and the open marketplace transporter indication, or generating a reputation message for the one or more internal transporter indications and the open marketplace transporter indication. Thus, the transport task can assist the user decision to select a transporter by providing prices, ranks, and/or reviews for corresponding transporters. For example, when the server 110 provides the one or more internal transporter indications and/or the open marketplace indication, the server 110 determines that the triggering condition is satisfied. Then, the server can execute the transporter task by generating fare messages and/or reputation messages for the inhouse transporter, one or more partner transporters, and/or the external transporter of the open marketplace system.

In further examples, the transportation task is a preorder task. The server 110 can generate a preorder based on the one or more load identifiers. For example, to generate the first order, the server 110 assign the transporter to the preorder to generate the first order. In some examples, the at least one trigger condition includes an elapsing of a first predetermined time period after generating the preorder without assigning the transporter, and the triggered action includes providing an order creation escalation message. In further examples, to execute the preorder task, the server 110 provides the order creation escalation message in response to the elapsing of the first predetermined time period after generating the preorder without assigning the transporter. For example, when the server 110 has not received a user input or any suitable command to assign a transporter to a preorder for the one or more load identifiers for a predetermined time period after the server 110 generated the preorder, the server 110 can generate and execute a preorder task to provide an order escalation message to the user for the transportation company to create an order by assigning a transporter to the preorder.

In further examples, the transportation task is an order task. In some examples, the at least one trigger condition includes an elapsing of a predetermined time period after generating the first order without assigning a driver, and the triggered action includes providing a driver assignment escalation message. In further examples, to execute the order task, the server 110 includes providing the driver assignment escalation message in response to the elapsing of the predetermined time period. For example, when the server 110 has not received a user input or any suitable command to assign a driver to an order for a predetermined time period after the server 110 generated the order, the server 110 can generate and execute an order task to provide a driver assignment escalation message to the user for the transportation company to assign a driver to the order.

In further examples, the transportation task is another order task. In some examples, the at least one trigger condition includes an elapsing of a predetermined time period after an estimated time arrival for the first order, and the triggered action includes providing an order escalation message. In further examples, to execute the order task, the server 110 further provides the order escalation message in response to the elapsing of the predetermined time period. For example, when the server 110 has not received an indication from a driver, via a driver computing device, that the driver arrived at the pickup location or the drop-off location by the estimated arrival times on the pickup location or the drop-off location, respectively, the server 110 can generate and execute an order task to provide an order escalation message to arrive at the pickup location or the drop-off location soon.

In further examples, the transportation task is an order task. In some examples, the at least one trigger condition includes: generating a second order having at least one of: a same drop-off location, a shared route, or a same delivery date as the first order, and the triggered action includes providing an order grouping message. In further examples, to execute the transportation task, the server 110 provides the order grouping message in response to generating the second order. For example, the server 110 can identify the trigger condition indicating that the orders have the same pickup location, the same drop-off location, the same or similar pickup time, the same or similar drop-off time, and/or a shared route between the load identifiers. Then, when the server 110 can determines that the trigger condition has been met, the server 110 can generate and execute an order task to provide an order grouping message to the user for the transportation company to group the orders.

FIG. 20 is a graphical user interface for task generation and/or management. For example, the server 110 can generate a GUI screen 2000 to generate and manage one or more tasks. In some examples, the server 110 can generate and/or update a task 2002 that is associated with the one or more load identifiers 2004 and that defines at least one trigger condition 2006 (e.g., missed pickup estimated arrival time, etc.) and a triggered action 2008 (e.g., providing driver escalation message) to be performed when the at least one trigger condition 2006 is satisfied. In further examples, the GUI screen 2000 can further include a list of tasks (e.g., tasks associated with one or more orders, tasks one or more load identifiers, all tasks for the transportation company). A task in the list of task can show a status of the task (e.g., open or closed), a creation time, a name of the task, a task type (e.g., order escalation, transportation escalation, driver escalation, preorder escalation, transporter escalation, etc.). In further examples, a task can include one or more subtasks, each subtask defines another trigger condition and a trigger action to be performed when another trigger condition is satisfied.

Accordingly, the server 110 implementing the TMS system, via the task generation and execution described with respect to the process 1900 of FIG. 19 and the GUI screen 2000 of FIG. 20, for example, provide a TMS system with customizable functionality that reduces user input, interaction with, and navigation of the TMS system. These task-related features also provide a TMS system that more quickly detects and reacts to changing conditions of the TMS system than otherwise possible and/or detects and reacts to changing conditions of the TSM system that otherwise may not be recognized. Thus, the task generation and execution of the TMS system can provide a more efficient TMS system with improved resource allocation and improved communication and distribution of information.

FIG. 21 is a flowchart illustrating an example method and technique for grouping in a TMS. The flowchart of FIG. 21 utilizes various system components in the TMS that are described below. In some examples, the process 2100 may be carried out by the server(s) 102 and/or the client device(s) 122, 124 illustrated in FIG. 1, e.g., employing circuitry and/or software configured according to the block diagram illustrated in FIG. 1. In some examples, the process 2100 may be carried out by any suitable apparatus or means for carrying out the functions or algorithm described below. Additionally, although the blocks of the process 2100 are presented in a sequential manner, in some examples, one or more of the blocks may be performed in a different order than presented, in parallel with another block, or bypassed.

At block 2102, a server (e.g., one or more server(s) 110, also referred to as the server 110) receives one or more load identifiers. In some examples, block 2102 is substantially similar to block 402.

At block 2104, the server 110 provides a group of the one or more load identifiers based on at least one of: a pickup location, a drop-off location, a delivery date, or a route of each of the one or more load identifiers. For example, the server 110 can provide a message to the user for the transportation company indicating that multiple load identifiers can be grouped for an order based on one or more grouping conditions. The grouping condition can include the same pickup location of the loads corresponding to the multiple load identifiers, the same drop-off location of the loads, the same or similar delivery date of the loads, and/or a shared route between routes of the loads. However, the grouping condition is not limited to the list recited above. For example, the grouping condition can further include levels of requested service for the loads, types of loads, or any other suitable conditions.

At block 2106, the server 110 provides one or more internal transporter indications and an open marketplace transporter indication for an open marketplace transporter in an open marketplace system. In some examples, block 2106 is substantially similar to block 404 of FIG. 4.

At block 2108, the server 110 receives a user input to select the group and a selected transporter indication among the one or more internal transporter indications and the open marketplace transporter indication. In some examples, block 2108 is substantially similar to block 406 of FIG. 4.

At block 2110, the server 110 generates a first order based on the group and the selected transporter indication. In some examples, block 2110 is substantially similar to block 408 of FIG. 4. Additionally or alternatively, the server 110 can provide a message to the user for the transportation company indicating that multiple orders can be grouped based on one or more order grouping conditions that the server 110 determines to be satisfied (e.g., based on receipt and evaluation of details of the orders). The order grouping condition can include the same pickup location of the orders, the same drop-off location of the orders, the same or similar delivery date of the orders, and/or a shared route between the orders. However, the order grouping condition is not limited to the list recited above. For example, the grouping condition can further include levels of requested service for the orders, types of loads, types of trucks to be used for the orders, reputation ranks of the transporters for the orders, or any other suitable conditions.

At block 2112, the server 110 outputs the first order to an internal transporter corresponding to the selected transporter indication in response to the selected transporter indication being selected from the one or more internal transporter indications. In some examples, block 2112 is substantially similar to block 410 of FIG. 4.

At block 2114, the server 110 outputs the first order to the open marketplace system in response to the selected transporter indication being selected from the open marketplace transporter indication. In some examples, block 2114 is substantially similar to block 412 of FIG. 4.

FIG. 22 is a flowchart illustrating an example method and technique for automation in a TMS. The flowchart of FIG. 22 utilizes various system components in the TMS that are described below. In some examples, the process 2200 may be carried out by the server(s) 102 and/or the client device(s) 122, 124 illustrated in FIG. 1, e.g., employing circuitry and/or software configured according to the block diagram illustrated in FIG. 1. In some examples, the process 2200 may be carried out by any suitable apparatus or means for carrying out the functions or algorithm described below. Additionally, although the blocks of the process 2200 are presented in a sequential manner, in some examples, one or more of the blocks may be performed in a different order than presented, in parallel with another block, or bypassed.

At block 2202, the server 110 receives one or more load identifiers. In some examples, each load identifier can be associated with a pickup location and a drop-off location. In some examples, block 2202 is substantially similar to block 402 of FIG. 4.

At block 2204, the server 110 generates a preorder based on the one or more load identifiers. In some examples, block 2204 is substantially to the preorder generation associated and described with respect to FIGS. 5 and 6.

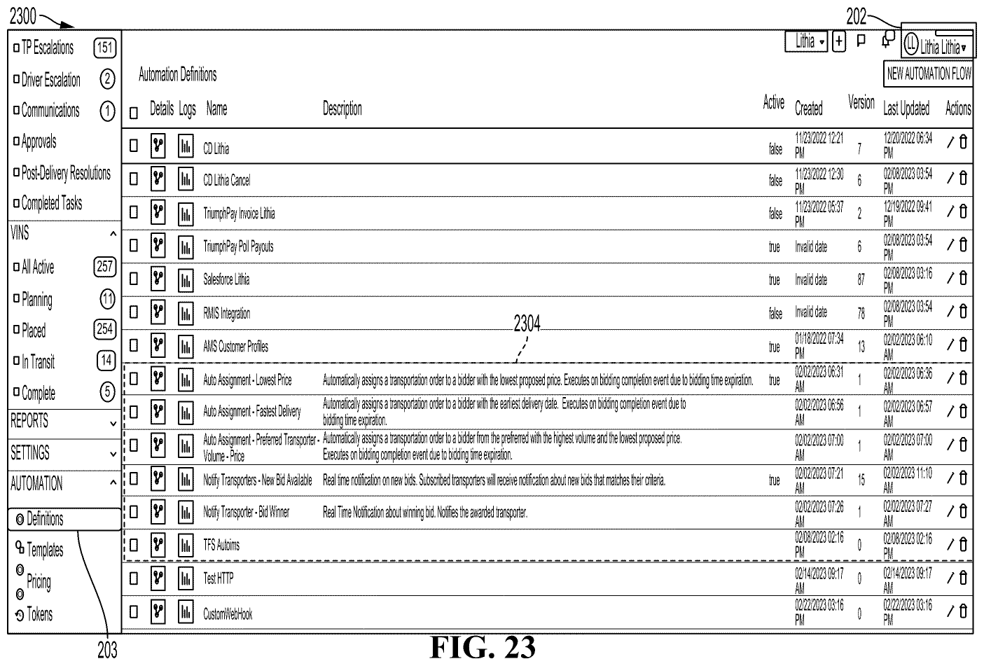

At block 2206, the server 110 provides a graphical automation definition interface including multiple automation rule templates. For example, as shown in FIG. 23, the server 110 can generate a GUI screen 2300 to be shown in the client device 122, 124 to provide the graphical automation definition interface including multiple automation rule templates. In some examples, the server 110 can provide an indication 2302 (e.g., a button, a box, or any suitable GUI component) to provide a graphical automation definition interface 2304. For example, the user 202 can select the indication 2302 to use an automation rule template for automation of a transportation process. Then, the server can provide the graphical automation definition interface 2304 including a list of automation rule templates. In some examples, the list of automation rule templates can include an auto assignment of a transporter providing the lowest price, an auto assignment of a transporter with fastest delivery, an auto assignment of a preferred transporter having a preferred volume and price, a real-time notification of a new transporter with a new bid, a real time notification of a winning bid, or any other suitable automation rule templates. In some examples, some automation rule templates can be predesigned based on common TMS processes and configured by the user 202. In some examples, the user 202 can automatically select a transporter based on an automatic rule template and certain conditions (e.g., lowest price, most recent used transporter, preferred transporter, a transporter having the largest capacity for transportation). It should be appreciated that the user 202 can automate any other suitable process using another automation rule template.

At block 2208, the server 110 receives a user input for a first automation rule template of the multiple automation rule templates. Referring again to FIG. 23, the user 202 can select an automation rule template among the list of automation rule templates in the graphical automation definition interface 2304, and the server 110 receive the selected automation rule template as a user input.

In some examples, the first automation rule template can define at least one trigger condition to perform a triggered action. In further examples, the user input includes a configuration input to configure the at least one trigger condition of the first automation rule template. In further examples, the configuration input further adds at least one another trigger condition to trigger another trigger action. In some examples, the at least one trigger condition includes at least one of: a transporter providing a lowest proposed price, a predetermined transporter, a transporter with a fastest delivery speed, a transporter having a highest volume capacity, or a transporter with a highest rate. In some examples, the first automation rule template further defines a triggered action to be performed when the at least one trigger condition is satisfied. In further examples, the trigger action includes selecting the first transporter. In some examples, the server 110 can provide a user-friendly graphical user interface to configure a trigger condition and/or a triggered action of an automation rule or an automation rule template.

In some examples, blocks 2206 and 2208 can be performed at a different time from blocks 2202, 2204, 2210, and 2212 in that blocks 2206 and 2208 are to configure and operate automation rule templates for other processes in blocks 2202, 2204, 2210, and 2212. For example, blocks 2206 and 2208 can be performed before or in parallel with performance of blocks 2202 or 2204.

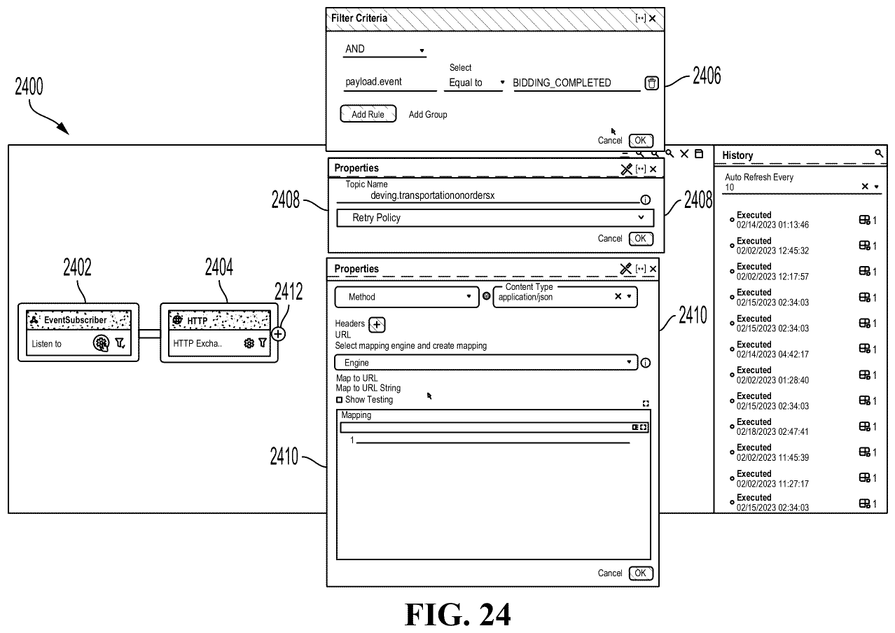

FIG. 24 is an example graphical user interface for user configuration of an automation rule template in a TMS. For example, in response to the user input to select an automation rule template in FIG. 23 or to generate an automation rule template, the server 110 can generate a GUI screen 2400 to be shown in the client device 122, 124 such that the user can configure the automation rule template. In some examples, an automation rule template can include at least one predetermined trigger condition and a predetermined triggered action. Thus, in some scenarios, the user does not need to configure the automation rule template. In other examples, the server 110 can provide a user-friendly GUI screen 2400 to generate or configure an automation rule template. In some examples, the server 110 allows the user to add, delete, and/or configure a GUI component 2402 in the GUI screen 2400. For example, an automation rule template can include a first GUI component 2402. In some examples, the first GUI component 2402 can define at least one trigger condition (a transporter providing a lowest proposed price, a predetermined transporter, a transporter with a fastest delivery speed, a transporter having a highest volume capacity, a transporter with a highest rate, and/or any other suitable trigger condition). For example, a trigger condition can be defined using a filter 2406. In some examples, the filter 2406 can filter transporter based on one or more thresholds. For example, the filter 2406 can select transporters, which suggest lower than a threshold price, take shorter average delivery times than a threshold deliver time, and/or have higher volume capacities than a threshold volume capacity.

It should be appreciated that the at least one trigger condition are not limited to the one or more transporters. For example, the at least one trigger condition can be a load-related condition (e.g., whether a predetermined time period after receiving the one or more load identifiers elapses, whether each load identifier of the one or more other load identifiers is associated with the pickup location and the drop-off location of the one or more load identifiers, etc.), an order-related condition (e.g., whether an order departs on time, whether an order arrives on time, etc.), a driver-related condition (e.g., whether a predetermined time period after an order was created without a driver being assigned elapses, whether a driver arrives at a pickup location, etc.) or any other suitable condition.

In further examples, a trigger condition can be defined by selecting a predetermined condition 2408. For example, the server 110 can provide an option in the first GUI component 2402 to select one or more predetermined trigger condition (e.g., using a drop-box menu, an autosuggest function, check-boxes). In further examples, the server 110 can provide another option in the first GUI component 2402 such that the user can configure the trigger condition (e.g., by coding the trigger condition or by using a mapping tool to map a transportation system entity/group (e.g., transporters, orders, preorders, etc.) to another transportation system entity/group to configure the trigger condition).

In further examples, the automation rule template can further include a second GUI component 2404. In some examples, the second GUI component 2404 can further define at least one trigger condition. For example, if the first GUI component 2402 can define a first trigger condition (e.g., transporters having volumes higher than a predetermined volume), the second GUI component 2404 can define a second trigger condition (e.g., a transporter proposing the lowest price) among the result (e.g., transporters having volumes higher than a predetermined volume).

In some examples, the server 110 can allow the user to add another GUI component. For example, the GUI screen 2400 can provide an indication 2412 to add a GUI component. When the user selects the indication 2412 to add a GUI component, the server can provide an option to select a type of the GUI component. For example, the type can correspond to the filter 2406, the selection 2408, the coding 2410 to configure at least one trigger condition. Thus, the server 110 allows the user to add a GUI component to configure at least one trigger condition in various ways. In further examples, the new GUI component can be connected to any suitable component (e.g., the first GUI component 2402, the second GUI component 2404, etc.). For example, the new GUI component can be connected to the first GUI component 2402 for a different trigger condition from the trigger condition of the second GUI component 2404. In some examples, the first GUI component 2402 defines a trigger condition to select transporters having volumes higher than a threshold volume, and the second GUI component 2404 defines another trigger condition to select a transporter proposing the lowest price among the transporters produced from the first GUI component 2402. In some scenarios, the new GUI component can define a different trigger condition for one or more preorders having pickup locations and drop-off locations that the selected transporters from the first GUI component 2402 can cover. Thus, the server 110 can provide a user-friendly graphical user interface to configure a trigger condition of an automation rule template.

In some examples, a GUI component can define a triggered action. In some examples, a triggered action can include generating an order, assigning a transporter to a preorder, providing a notification, assigning a driver, or performing any other suitable triggered action. In some examples, a triggered action of a GUI component can be defined using the selection 2408 and/or the coding 2410. In some example, a GUI component can define a trigger condition and a triggered action together. In other examples, a GUI component can define a trigger condition and another GUI component can define a triggered condition. For example, if the first GUI component 2402 can define a first trigger condition (e.g., a transporter proposing the lowest price), the second GUI component 2404 can define a triggered action (e.g., generating an order by assigning the transporter to a preorder). In some scenarios, when the server 110 identifies a user input to use the automation rule template to select a transporter proposing the lowest price in the first GUI component 2402, the second GUI component 2404 defines a triggered action, which is to generate an order when a preorder is generated by automatically assigning the transporter to the preorder.

In further examples, a GUI component to define a triggered action can be connected to any suitable component (e.g., the first GUI component 2402, the second GUI component 2404, etc.). For example, the new GUI component can be connected to the first GUI component 2402 and perform another triggered action based on the result of the first GUI component 2402. In some examples, the first GUI component 2402 defines a trigger condition to select a transporter proposing the lowest price and the second GUI component 2404 defines a triggered action to generate an order based on the selected transporter. Then, the new GUI component can define another triggered action to send a notification about the selection to the transporter. Thus, the server 110 can provide a user-friendly graphical user interface to configure a trigger condition and/or a trigger action of an automation rule template.

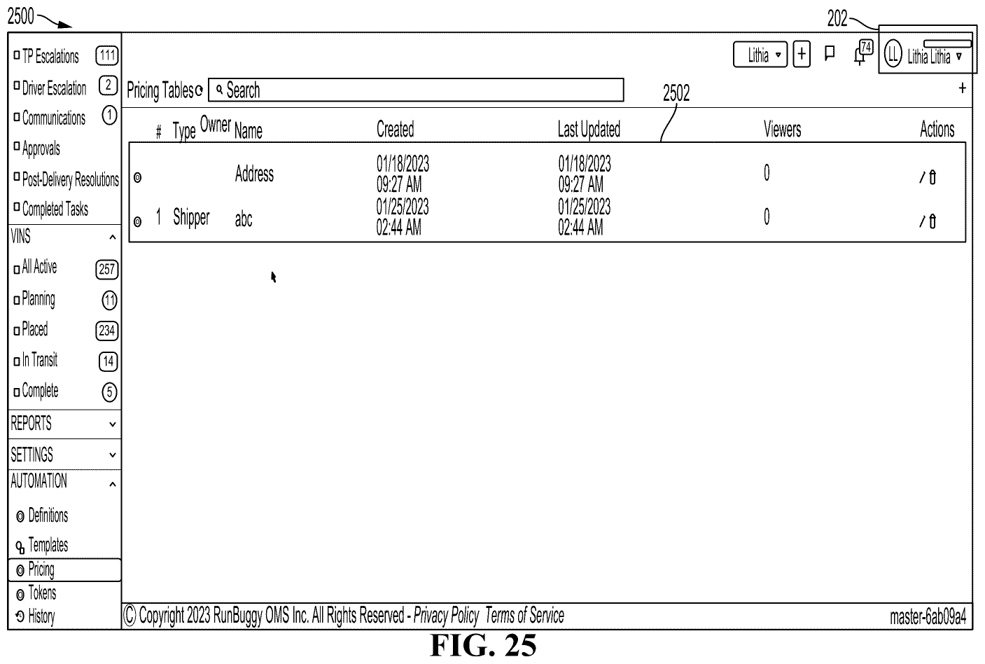

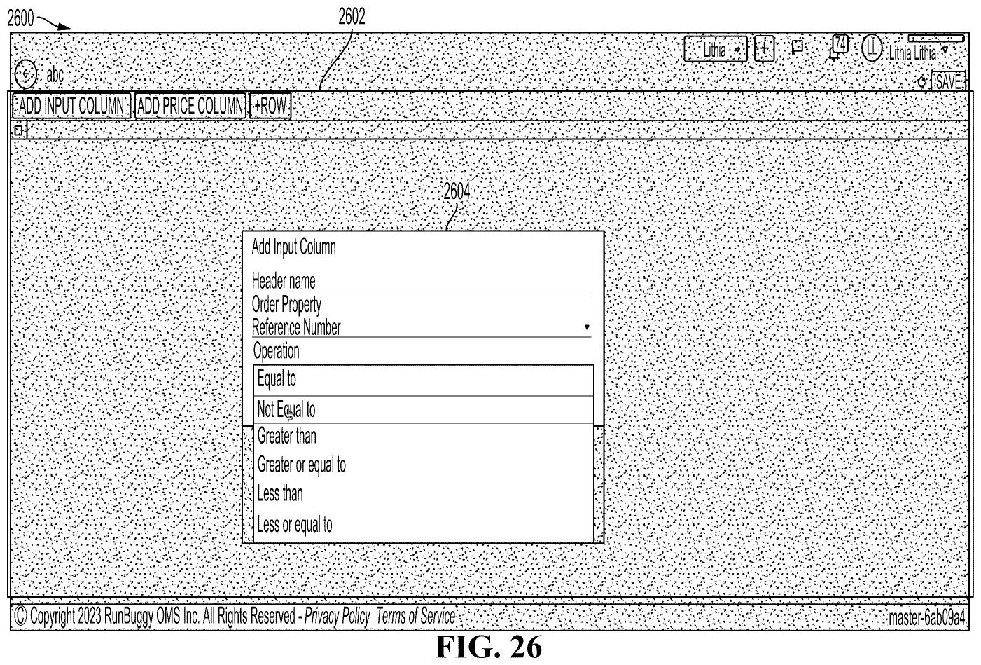

In further examples, it should be appreciated that the automation rule template can be configured in a different way. For example, the automation rule template can be configured by using a root table as shown in FIG. 25. Referring to FIG. 25, the server 110 can generate a GUI screen 2500 to be shown in the client device 122, 124 such that the user 202 can configure the automation rule template using a root table 2502. FIG. 25 shows a list of root tables while FIG. 26 shows an example root table of the list of root tables in FIG. 25. Referring to FIG. 26, the server 110 provide a GUI screen 2600 to allow the user 202 to configure a root table 2602 for an automation rule template. For example, the user 202 can define a trigger condition 2604 by adding a column in the root table 2602 using a filter. It should be appreciated that the root table 2602 can be configured in any other suitable way. For example, the trigger condition 2604 and/or a triggered action can be defined using a code, a mapping tool, a selection box, or any other suitable tool.

At block 2210, the server 110 identifies a first transporter of multiple transporters for the one or more load identifiers in response to the user input. In some examples, the first transporter satisfies the at least one trigger condition of the first automation rule template. It should be appreciated that it is not limited to the transporter to be identified in response to the user input.

In some examples shown in FIG. 24, the server 110 can identify the first transporter of multiple transporters where the first transporter satisfies the at least one trigger condition configured in the first GUI component 2402 and/or the second GUI component 2404 of the first automation rule template. In some examples, the server 110 can identify the first transporter with respect to the preorder generated at block 2204. For example, the server 110 can apply the first automation rule template selected by a user input at block 2208 to the preorder generated at block 2204. In some examples, the server 110 can first identify multiple transporters that are able to deliver one or more loads corresponding to the one or more identifiers. For example, the multiple identified transporters cover the pickup location and the drop-off location associated with the one or more load identifiers. In further examples, the multiple identified transporters can handle the type(s) of the one or more loads. Alternatively or in addition, the server 110 can identify the first transporter among the multiple transporters where the first transporter satisfies the one or more trigger condition. In some examples, the first transporters which satisfy the trigger condition can be an output of the first GUI component 2402 and/or the second GUI component 2404 in the first automation rule template.

At block 2212, the server 110 generates a first order based on the one or more load identifiers and the first transporter by performing the triggered action in response to satisfaction of the at least one trigger condition. Thus, the triggered action (e.g., generating the first order) can be automatically performed when the server identifies that the at least one trigger condition is satisfied (e.g., the first transporter satisfying the at least one trigger condition). In some examples, a triggered action based on the at least one trigger condition can include: generating an order, assigning a transporter to a preorder, providing a notification, assigning a driver, performing any other suitable triggered action. For example, the triggered action can be to send a notification. In some examples, he server 110 can transmit a notification to other transporters of the multiple transporters indicating that the first transporter satisfies the at least one trigger condition of the first automation rule template in response to the user input. In further examples, the server 110 can transmit a notification to other transporters of the plurality of transporters indicating that the first transporter is selected for the one or more load identifiers in response to the user input.

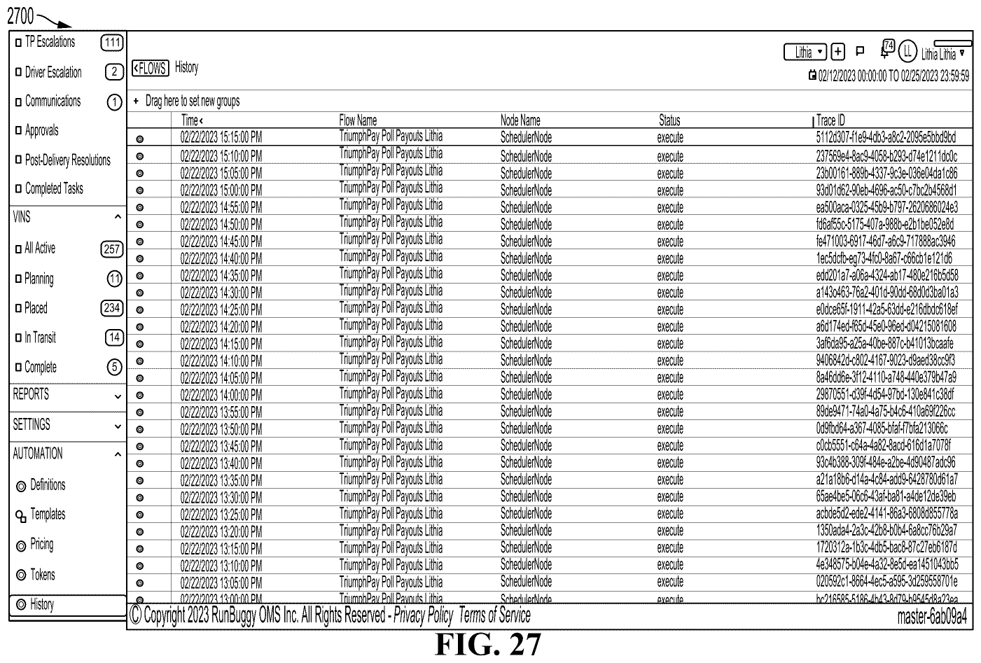

In some example, the server 110 can provide a GUI screen to shows history data to track load identifiers, preorders, transporters, and/or orders to verify whether the automation rule template is properly operated or the automation rule template is operated as the user 202 configured the automation rule template using the GUI in FIG. 24 or a root table in FIG. 26. Referring to FIG. 27, the server 110 provides a GUI screen 2700 including history data to show how orders, preorder, or any other suitable data are generated using one or more automation rule templates. In some examples, a data instance in history data includes a time, an operation type or flow name, a node name, a status, and/or a trace ID for the instance (e.g., order generation, preorder generation, transporter assignment, notification generation, etc.). In some examples, if the user finds an error of an instance, the server 110 can allow the user to update the instance or redo the operation corresponding to the instance.

FIG. 28 is a flowchart illustrating an example method and technique for system integration using a graphical user interface (GUI) in a TMS. The flowchart of FIG. 28 utilizes various system components in the TMS that are described below. In some examples, the process 2800 may be carried out by the server(s) 102 and/or the client device(s) 122, 124 illustrated in FIG. 1, e.g., employing circuitry and/or software configured according to the block diagram illustrated in FIG. 1. In some examples, the process 2800 may be carried out by any suitable apparatus or means for carrying out the functions or algorithm described below. Additionally, although the blocks of the process 2800 are presented in a sequential manner, in some examples, one or more of the blocks may be performed in a different order than presented, in parallel with another block, or bypassed.

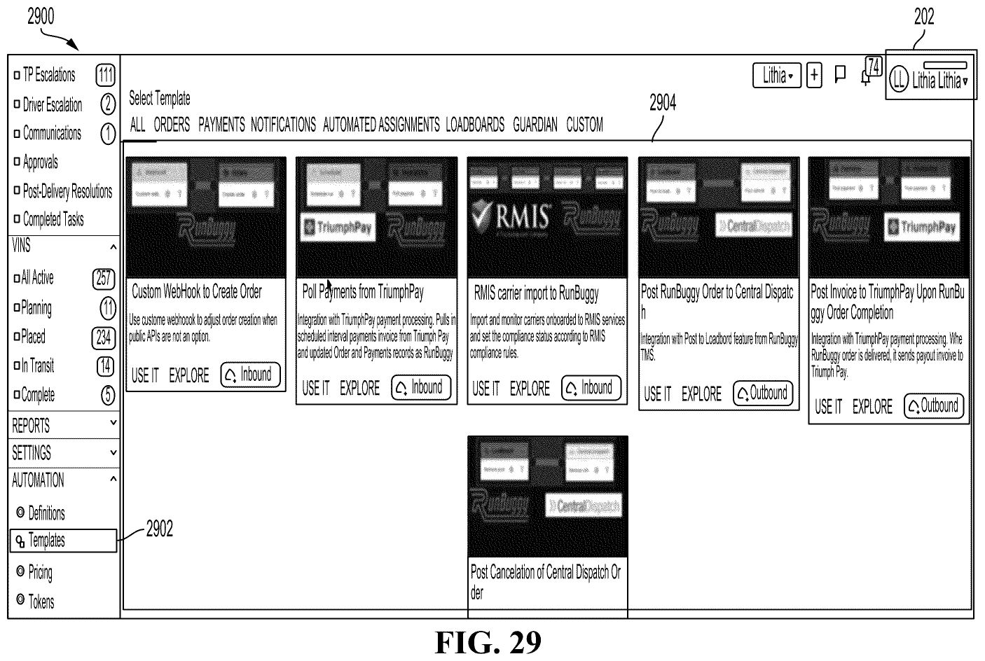

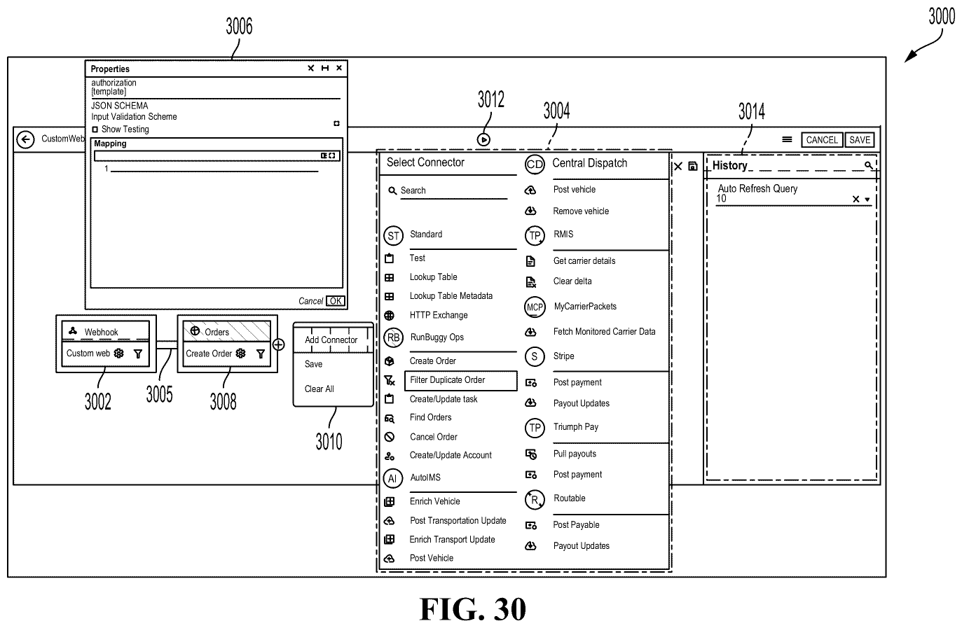

In some examples, the server 110 can perform the GUI-based system integration using a system integration template. Referring to FIG. 29, the server 110 can generate a GUI screen 2900 to be shown in the client device 122, 124 to provide the graphical system integration interface including multiple system integration templates. In some examples, the server 110 can provide an indication 2902 (e.g., a button, a box, or any suitable GUI component) to provide a graphical system integration interface 2904. For example, the user 202 can select the indication 2302 for a system integration process. Then, the server 110 can provide the graphical system integration interface 2904 including a list of system integration templates. In some examples, the list of system integration templates can integrate any suitable external ancillary system (e.g., an external ancillary payment system, an external ancillary transporter system, an external ancillary TMS, or any other external ancillary suitable system) with the TMS. In some scenarios, the user 202 and transporters can use a carrier payments system. Unless the user 202 and the transporters replace the carrier payments system with the TMS, the user 202 and the transporters use the TMS and separately use the carrier payments system. However, the user 202 can use the TMS to manage payments for the transporters by integrating the carrier payments system with the TMS by establishing an application programming interface (API) between the two systems. In some examples, when an order is complete, the user can post an invoice for a transporter to the TMS, which can automatically post an invoice to the carrier payments system via an interface generated and/or applied by a system integration template. In further examples, the server 110 allows the user 202 to generate, initiate, modify, or view a system integration template using a GUI screen 3000 as shown in FIG. 30. The GUI-based system integration process at blocks 2802-2810 of FIG. 28 is explained below along with the GUI screen 3000 as shown in FIG. 30.

Referring again to FIG. 28, at block 2802, the server 110 generates a first transportation panel on a graphical user interface. Referring again to FIG. 30, the GUI screen 3000 can include the first transportation panel 3002 as a GUI component where the first transportation panel 3002 represents a first transportation function for the TMS or the external ancillary system 150. In some examples, the first transportation function can include performing a transportation function in the TMS. However, it should be appreciated that the first transportation function can include receiving a transportation input from an external ancillary system 150 and/or transmitting a transportation output to an external ancillary system 150 with or without performing a transportation function in the TMS. In some examples, the server 110 allows the user 202 to select or configure the first transportation function among a list of transportation functions 3004 in a GUI subscreen. In some examples, the list of transportation functions 3004 can include multiple predetermined transportation functions such that the user 202 can select the first transportation function among the multiple predetermined transportation functions. In other examples, the list of transportation functions 3004 can include an indication to configure a transportation function (e.g., by mapping a transportation system entity to an entity in the external ancillary system 150, and/or coding a transportation function). In some examples, the server 110 allows the user 202 to configure the first transportation function (e.g., using a mapping tool 3006 for mapping a transportation system entity to an entity in the external ancillary system 150, and/or coding a transportation function).

In some examples, the first transportation function for the TMS can include at least one of: a load identifier-related function, a transporter-related function, an order-related function, a payment-related function, or any other suitable TMS-related function. In further examples, the load identifier-related function can include at least one of: generating one or more identifiers, posting the one or more identifiers, removing one or more identifiers, receiving information about one or more identifiers, or performing any other suitable load identifier-related function. In further examples, the transporter-related function can include at least one of: receiving external transporter information, receiving status information of an external transporter, or performing any other suitable transporter-related function. In further examples, the order-related function can include at least one of: generating an order, finding the order, canceling the order, generating a transportation task, finding the transportation task, canceling the transportation task, receiving information about an order, receiving information about a transportation task, or performing any other suitable order-related function. In even further examples, the payment-related function can include at least one of: posting a payment, receiving a status of the payment, posting a payable, or performing any other suitable payment-related function.

Referring again to FIG. 28, at block 2804, the server 110 generates a second transportation panel on the graphical user interface. Referring again to FIG. 30, the GUI screen 3000 can include the second transportation panel 3004 as another GUI component where the second transportation panel 3004 represents a second transportation function for an external ancillary system 150. In further examples, the TMS can be heterogeneous from the external ancillary system 150. In other examples, the first transportation panel 3002 represents the first transportation function for an external ancillary system 150 while the second transportation panel 3004 represents the second transportation function for the TMS. In some examples, the second transportation function for the external ancillary system 150 or the TMS can be similar to the first transportation function to include at least one of: a load identifier-related function, a transporter-related function, an order-related function, or a payment-related function. In some examples, the server 110 can provide a list of transportation functions 3004 where the list of transportation functions is associated with the first transportation function of the TMS. Then, the server 110 can receive a user input to select the second transportation panel corresponding to the second transportation function among the list of transportation functions. To generate the second transportation panel on the graphical user interface, the server 110 generates the second transportation panel in response to the user input.

For example, the first transportation function corresponding to the first panel 3002 is to receive one or more load identifiers from an external ancillary system 150 (e.g., load identifier generating system), while the TMS performs the second transportation function (e.g., generates an order) of the second panel 3004 based on the one or more load identifiers received via the first transportation function.

At block 2806, the server 110 identifies a first communication data format of the first transportation function and a second communication data format of the second transportation function. In some examples, the server 110 can identify the first communication data format and the second communication data format by receiving a user input indicating the data formats or the communication network 140 from the external ancillary system 150 or any other suitable data source. In other examples, the server 110 can possess various data formats of transportation functions in the database 118 and identify the first communication data format and the second communication data format by accessing the database 118. For example, the first transportation function corresponding to the first panel 3002 is to receive one or more load identifiers from an external ancillary system 150 in five-digit format while the second transportation function (e.g., generates an order) of the second panel 3004 uses the one or more load identifiers in four-letter format as an input. The server 110 can identify the communication data format for the one or more load identifiers from the external ancillary system 150, which is a five-digit format while the communication data format for the one or more load identifiers in the TMS is a four-letter format.

At block 2808, the server 110 generates a transportation integration link 3005 on the graphical user interface between the first transportation panel and the second transportation panel to define a TMS integration application programming interface (API) by mapping the first communication data format and the second communication data format. In the examples above, the server 110 can define a TMS integration API by defining an API that is configured to convert the five-digit format load identifiers to the four-letter load identifiers and that is configured to perform the second transportation function based on the converted the four-letter load identifiers via the TMS integration API. In some examples, the server 110 can configure at least one of the first communication data format of the first transportation function for the TMS integration application programming interface (API) or the second communication data format of the second transportation function for the TMS integration API. For example, to configure the first communication data format or the second communication data format for the TMS integration API, the server 110 can add or delete any suitable data in the first or second communication data format in the data format configuration for the TMS integration API. Additionally or alternatively, the server can perform suitable transportation function to configure the data format data for the TMS integration API. Thus, the TMS integration API can accurately map the first communication data format and the second communication data format.

In further examples, the server 110 can allow the user 202 to add a new panel 3010 to be connected to a previous panel (e.g., the second panel 3008 and/or the first panel 3002) to perform a new transportation function associated with a previous transportation function (e.g., the second panel 3008 of the second panel 3008 and/or the first panel 3002 of the first transportation function of the first panel 3002). The user 202 can select and/or configure the new transportation function among a list of transportation functions 3004. Similar to block 2806, the server 110 can identify communication data formats of the transportation function to be connected to the new transportation function of the new panel 3010 and the new transportation function. In further examples, similar to block 2808, the server 110 can generates another transportation integration link on the graphical user interface between the previous transportation panel and the new transportation panel 3010 to define another TMS integration API by mapping the previous communication data format of the previous transportation function and the new communication data format of the new transportation function.

In some examples, after configuring the TMS integration using the GUI screen 3000, the server 110 can provide an indication 3012 to simulate or test the configured TMS integration with test data. For example, the server 110 can possess various data formats of external ancillary systems 150 and generate test data using the various data formats to provide the test data to the configured system integration. In some examples, the GUI screen 3000 can further include a history section 3014 to show the test or simulation result of the test data in the configured system integration, which perform the first transportation function of the first panel 3002 and the second transportation function of the second panel 3008.

At block 2810, the server 110 communicates, via the TMS integration API being executed by the electronic processor of the server 110, between the TMS and the external ancillary system 150. In some examples, to communicate between the TMS and the external ancillary system 150, the server 110 can receive data from the external ancillary system 150, identify the second transportation function of the external ancillary system 150 for the data (e.g., as having output the data), identify the TMS integration API corresponding to the second transportation function of the ancillary system, and provide the data to the TMS via the TMS integration API. For example, the TMS integration API may map the data from a first format of the external ancillary system 150 to a second format of the TMS. In further examples, the server 110 can identify data to be output to the second transportation function of the external ancillary system 150, identify the TMS integration API corresponding to the second transportation function of the external ancillary system 150, and provide the data to the external ancillary system 150 via the TMS integration API. For example, the TMS integration API may map the data from a first format of the TMS to a second format of the external ancillary system 150. Accordingly, when communicating via the TMS integration API, the TMS integration API may map or translate the data from a format of the transmitting component to a format of the receiving component.

In some examples, the server 110 can generate test input data to be input to the first transportation function for the TMS system or to the second transportation function for the ancillary system and provide the test input data on the graphical user interface to the first transportation panel. The server 110 can determine test output data from the second transportation function with the test input data in the first transportation function or from the first transportation function with the test input data in the second transportation function. The server 110 can provide the test output data on the graphical user interface.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

1. An electronic transportation management system comprising:
a server system comprising:
a network interface configured to communicatively couple the server system to a network,
a memory storing computer-executable instructions, and
one or more electronic processors, the one or more electronic processors configured to retrieve and execute the computer-executable instructions to cause the server system to:
receive one or more load identifiers,
provide one or more internal transporter indications and an open marketplace transporter indication for an open marketplace system,
receive a user input, via the network interface, to select a selected transporter indication among the one or more internal transporter indications and the open marketplace transporter indication,
generate a first order based on the one or more load identifiers and the selected transporter indication,
output the first order to an internal transporter corresponding to the selected transporter indication in response to the selected transporter indication being selected from the one or more internal transporter indications, and
output the first order to the open marketplace system in response to the selected transporter indication being selected from the open marketplace transporter indication.

2. The electronic transportation management system of claim 1, wherein a first load identifier of the one or more load identifiers is associated with first load transportation information comprising a pickup location and a drop-off location.

3. The electronic transportation management system of claim 1,
wherein the server system is further to generate a preorder based on the one or more load identifiers, and
wherein to generate the first order, the server system is further to: assign the selected transporter indication to the preorder to generate the first order.

4. The electronic transportation management system of claim 1, wherein the one or more internal transporter indications is indicative of an inhouse transporter or one or more partner transporters.

5. The electronic transportation management system of claim 1, wherein the server system is further to:
generate a second order based on one or more other load identifiers; and
combine the first order and the second order based on at least one of: a pickup location, a drop-off location, a delivery date, a status indication, or a route from the pickup location to the drop-off location of each of the first order and the second order.

6. A method for an electronic transportation management system, comprising:
receiving, by an electronic processor, one or more load identifiers;
providing, by the electronic processor, one or more internal transporter indications and an open marketplace transporter indication for an open marketplace system;
receiving, by the electronic processor, a user input to select a selected transporter indication among the one or more internal transporter indications and the open marketplace transporter indication;
generating, by the electronic processor, a first order based on the one or more load identifiers and the selected transporter indication;
in response to the selected transporter indication being selected from the one or more internal transporter indications, outputting, by the electronic processor, the first order to an internal transporter corresponding to the selected transporter indication; and
in response to the selected transporter indication being selected from the open marketplace transporter indication, outputting, by the electronic processor, the first order to the open marketplace system.

7. The method of claim 6, wherein a first load identifier of the one or more load identifiers is associated with first load transportation information comprising a pickup location and a drop-off location.

8. The method of claim 6, further comprising:
generating, by the electronic processor, a preorder based on the one or more load identifiers,
wherein generating the first order comprises: assigning the selected transporter indication to the preorder to generate the first order.

9. The method of claim 8, further comprising:
receiving, by the electronic processor, one or more other load identifiers;
determining, by the electronic processor, a group of the one or more load identifiers and the one or more other load identifiers based on at least one of: a pickup location, a drop-off location, a delivery date, or a route associated with each of the one or more load identifiers and the one or more other load identifiers; and
providing, by the electronic processor, the group for the preorder,
wherein generating the preorder comprising: generating the preorder based on the group.

10. The method of claim 6, wherein the one or more internal transporter indications is indicative of an inhouse transporter or one or more partner transporters.

11. The method of claim 10, further comprising:
determining, by the electronic processor, the one or more partner transporters among a plurality of partner transporters based on at least one of: a pickup location associated with the one or more load identifiers, a drop-off location associated with the one or more load identifiers, or a usage indication of the one or more partner transporters.

12. The method of claim 10, wherein the selected transporter indication is indicative of a first partner transporter of the one or more partner transporters, and
wherein the method further comprises: sharing the first order with the first partner transporter.

13. The method of claim 10, wherein outputting the first order to the internal transporter corresponding to the selected transporter indication comprises: outputting the first order to a driver of the internal transporter.

14. The method of claim 10, further comprising:
generating, by the electronic processor, other orders for the inhouse transporter, the one or more partner transporters, and an open marketplace transporter of the open marketplace system;
dynamically accessing, by the electronic processor, an internal database for a first subset of the other orders for the inhouse transporter to obtain a first status of the first subset of the other orders;
dynamically accessing, by the electronic processor, the internal database for a second subset of the other orders for the one or more partner transporters to obtain a second status of the first subset of the other orders;
dynamically obtaining, by the electronic processor, a third status of a third subset of the other orders for the open marketplace transporter from the open marketplace system; and
providing, by the electronic processor, a first status of the first subset of the other orders, a second status of the second subset of the other orders, and a third status of the third subset of the other orders.

15. The method of claim 6, further comprising:
in response to the selected transporter indication being selected from the open marketplace transporter indication, obtaining, by the electronic processor, a status of the first order from the open marketplace system.

16. The method of claim 15, wherein the status of the first order comprises an order creation indication from the open marketplace system.

17. The method of claim 6, further comprising:
generating, by the electronic processor, a second order based on one or more other load identifiers; and
combining, by the electronic processor, the first order and the second order based on at least one of: a pickup location, a drop-off location, a delivery date, a status indication, or a route from the pickup location to the drop-off location of each of the first order and the second order.

18. The method of claim 6, further comprising:
determining, by the electronic processor, whether the first order meets a triggering condition; and
generating, by the electronic processor, a task based on the first order meeting the triggering condition.

19. The method of claim 18, wherein the task comprises at least one selected from a group of combining the one or more load identifiers with other load identifiers based on the triggering condition or combining the first order with another order based on the triggering condition.

20. A nontransitory computer readable medium storing instructions that, when executed by an electronic processor, cause the electronic processor to:
receive one or more load identifiers,
provide one or more internal transporter indications and an open marketplace transporter indication for an open marketplace system,
receive a user input, via a network interface, to select a selected transporter indication among the one or more internal transporter indications and the open marketplace transporter indication,
generate a first order based on the one or more load identifiers and the selected transporter indication,
output the first order to an internal transporter corresponding to the selected transporter indication in response to the selected transporter indication being selected from the one or more internal transporter indications, and
output the first order to the open marketplace system in response to the selected transporter indication being selected from the open marketplace transporter indication.

21.-49. (canceled)
